(19) United States
(12) Patent Application Publication
(10) Pub. No.: US 2014/0124551 A1
(43) Pub. Date: May 8, 2014

(54) VEHICLE RACK SYSTEM WITH A BICYCLE-GRIPPING CARRIER

(71) Applicant: Yakima Innovation Development Corporation, (US)

(72) Inventors: David Condon, Wilsonville, OR (US); Chris Sautter, Portland, OR (US); James Buckroyd, Portland, OR (US)

(73) Assignee: Yakima Innovation Development Corporation, Georgetown Grand Cayman (KY)

(21) Appl. No.: 13/855,493

(22) Filed: Apr. 2, 2013

Related U.S. Application Data
(60) Provisional application No. 61/640,612, filed on Apr. 30, 2012.

(51) Int. Cl. B60R 9/048; B60R 9/10

(52) U.S. Cl. CPC B60R 9/048; B60R 9/10
USPC 224/324

(57) ABSTRACT

Roof-mounted vehicle rack system including a load carrier. In some embodiments, the load carrier may be a bicycle carrier having an elongate base and an arm equipped with a frame-gripping device. The frame-gripping device may be operated with an actuating member, which may be centered transversely on the base for equal accessibility from either lateral side of the carrier. The actuating member and the arm may be mounted separately to the base at respective positions that are spaced along the base from each other.

### CROSS-REFERENCE TO PRIORITY APPLICATION

This application is based upon and claims the benefit under 35 U.S.C. §119(e) of U.S. Provisional Patent Application Ser. No. 61/640,612, filed Apr. 30, 2012, which is incorporated herein by reference in its entirety for all purposes.

### CROSS-REFERENCES TO OTHER MATERIALS

This application incorporates herein by reference the following patent document in its entirety for all purposes: U.S. Patent Application Publication No. 2013/0062379 A1, published Mar. 14, 2013.

### INTRODUCTION

The popularity of recreational and competitive cycling has grown substantially in recent years, with a corresponding expansion in the number of different bike designs and configurations. As a result, the demand for bicycle carriers to transport bikes of varying dimensions and designs on cars and other vehicles also has grown significantly.

Roof-mounted bicycle carriers (“rooftop carriers”) can be used to transport bicycles above a vehicle. The carriers can be designed to engage various parts of a bicycle, including both wheels, the front fork, a suitable section of the bicycle's frame, or a combination thereof, among others. However, a rooftop carrier can be difficult to reach and manipulate during bicycle loading and unloading, particularly on a larger vehicle and when the user is of smaller stature.

Improved rooftop carriers for transporting bicycles are needed.

### SUMMARY

The present disclosure provides a roof-mounted vehicle rack system including a load carrier. In some embodiments, the load carrier may be a bicycle carrier having an elongate base and an arm equipped with a frame-gripping device. The frame-gripping device may be operated with an actuating member, which may be centered transversely on the base for equal accessibility from either lateral side of the carrier. The actuating member and the arm may be mounted separately to the base at respective positions that are spaced along the base from each other.

### BRIEF DESCRIPTION OF THE DRAWINGS

FIG. 1 is a view of an exemplary vehicle rack system mounted to the roof of a vehicle and including a frame-gripping bicycle carrier in a storage configuration, in accordance with aspects of the present disclosure.

FIG. 2 is a side view of the bicycle carrier of FIG. 1 in a use configuration, namely, loaded with a bicycle that is secured to the carrier with a frame-gripping device and a pair of wheel-binding devices, in accordance with aspects of the present disclosure.

FIG. 3 is a cross-sectional view of the bicycle carrier of FIG. 2, taken generally along line 3-3 of FIG. 2 through a base and one of the wheel-binding devices of the carrier.

FIG. 4 is a plan view of an arm of the bicycle carrier of FIG. 1, taken in isolation and with a gripping device at the end of the arm in an open configuration, ready to receive a frame portion of a bicycle, in accordance with aspects of the present disclosure.

FIG. 5 is a fragmentary view of the distal end of the arm of FIG. 4, taken generally at the region indicated at “5” in FIG. 4, with a cover portion or housing of the gripping device removed.

FIG. 6 is another fragmentary view of the arm of FIG. 4, taken generally as in FIG. 5 after removal of an outer body portion of each claw member of the gripping device to reveal an inner frame of the claw member that is connected to a cable.

FIG. 7 is a fragmentary view of a longitudinally central region of the bicycle carrier of FIG. 1, with the arm of the carrier extending upwardly and jaws at the end of the arm closed.

FIG. 8 is a fragmentary, longitudinal sectional view of the bicycle carrier of FIG. 1, taken generally along line 8-8 of FIG. 7 and showing a portion of an actuation assembly that closes and opens jaws of the gripping device, with a manually-engageable actuating member of the assembly positioned in an open, bicycle-loading/unloading configuration such that the jaws at the end of the arm of the carrier are open.

FIG. 9 is another fragmentary, longitudinal sectional view of the bicycle carrier of FIG. 1, taken generally as in FIG. 8 with the actuating member positioned in a closed, storage or bicycle-securing configuration such that the jaws at the end of the arm of the carrier are closed and locked.

FIG. 10 is a fragmentary plan view of selected aspects of a linkage of the actuation assembly of FIG. 8, taken generally along line 10-10 of FIG. 8.

FIG. 11 is a bottom view of selected aspects of the actuating member of FIG. 9, taken generally along line 11-11 of FIG. 9.

FIG. 12 is an exploded, partially sectional view of selected aspects of the actuation assembly of FIG. 9, particularly a portion of the actuating member, taken generally along line 12-12 of FIG. 11, and an upper portion of a proximal anchor that meshes with the actuating member to fix the anchor.

FIG. 13 is a generally isometric view of the upper portion of the proximal anchor of FIG. 12.

FIG. 14 is a plan view of the upper portion of the proximal anchor of FIG. 12.

FIG. 15 is a schematic view of the actuation assembly and gripping device of the bicycle carrier of FIG. 1, with the proximal anchor locked and the jaws of the gripping device closed without a bicycle between the jaws.

FIG. 16 is another schematic view of the actuation assembly and gripping device of FIG. 15, after manipulation of an actuating member of the actuation assembly to unlock the proximal anchor and open the jaws of the gripping device, and with a frame portion of a bicycle near the gripping device.

FIG. 17 is still another schematic view of the actuation assembly and gripping device of FIG. 15, with the actuating member pivoted partway toward its fully closed configuration, the frame portion of the bicycle received between the jaws of the gripping device, and the jaws of the gripping device closed slightly from their fully open configuration but not yet in contact with the frame portion of the bicycle.

FIG. 18 is yet another schematic view of the actuation assembly and gripping device of FIG. 15, with the actuating member pivoted farther toward its fully closed configuration, the frame portion of the bicycle engaged by the jaws of the gripping device, and a tension spring of the actuation assembly stretched.

FIG. 19 is yet still another schematic view of the actuation assembly and gripping device of FIG. 15, with the actuating member in a fully closed configuration that locks the proximal anchor, which isolates the tension spring and locks the jaws of the gripping device around the frame portion of the bicycle.

FIG. 20 is a partially fragmentary, longitudinal sectional view of selected aspects of the bicycle carrier of FIG. 1, particularly a security system operable to prevent the bicycle carrier from being manipulated for disengagement from a crossbar of the vehicle rack system, when the actuating member is closed and then locked with a security lock to prevent unauthorized manipulation of the actuating member.

FIG. 21 is a fragmentary, longitudinal sectional view of the bicycle carrier of FIG. 20 with the actuating member nearly closed and not yet latched, and with a locking mechanism of the security system in a permissive configuration that permits manipulation of a coupler that attaches the carrier to a crossbar, for disengagement of the coupler from the crossbar.

FIG. 22 is another fragmentary, longitudinal sectional view of the bicycle carrier of FIG. 20, taken as in FIG. 21 after the actuating member has been fully closed and latched, and with the locking mechanism in a restrictive configuration that prevents manipulation and disengagement of the coupler.

FIG. 23 is a sectional elevation view of an illustrative coupler clamped to an illustrative crossbar.

FIG. 24 is a perspective view of another illustrative coupler showing operating levers in two positions.

FIG. 25 is an exploded isometric view of the coupler of FIG. 24.

FIG. 26 is an isometric view of the coupler of FIG. 24 with an upper cover removed.

FIG. 27 is a sectional view of the coupler of FIG. 24, taken generally along line 27-27 of FIG. 26.

FIG. 28 is a sectional view of the coupler of FIG. 24, taken generally along line 28-28 of FIG. 26, with a component (e.g., a rail and/or beam) disposed on an upper surface, and showing a locking pin in a locked position.

FIG. 29 is a sectional view of the coupler of FIG. 24, taken as in FIG. 28 with the locking pin in an unlocked position.

FIG. 30 is an exploded view of another exemplary gripping device disposed at the distal end of an arm of a carrier, with the gripping device having a pair of ratchets.

FIGS. 31 and 32 are fragmentary views of the gripping device of FIG. 30 showing one of the ratchets in a meshed configuration (FIG. 31) that blocks the jaws of the gripping device from opening, and a disengaged configuration (FIG. 32) that permits opening of the jaws.

FIG. 33 is a plan view of selected aspects of still another exemplary gripping device disposed at the distal end of an arm of a carrier, with the gripping device having a pair of ratchets.

FIG. 34 is a plan view taken as in FIG. 33, but with the jaws of the gripping device held open by forces transmitted by link members that extend along the arm.

### DETAILED DESCRIPTION

The present disclosure provides a roof-mounted vehicle rack system including a load carrier. In some embodiments, the load carrier may be a bicycle carrier having an elongate base and an arm equipped with a frame-gripping device. The frame-gripping device may be operated with an actuating member, which may be centered transversely on the base for equal accessibility from either lateral side of the carrier. The actuating member and the arm may be mounted separately to the base at respective positions that are spaced along the base from each other.

The bicycle carriers of the present disclosure may offer substantial advantages over other rooftop carriers. The carrier may be equipped with a frame-gripping device operable with an actuating member that is more ergonomically positioned, such as positioned at a lower elevation, closer to the roof of the vehicle, spaced from the base of the arm and movable independently of the arm, and/or more symmetrically positioned to permit access from either side of the vehicle. The carrier also or alternatively may include a locking mechanism for a coupler that attaches the carrier to a crossbar. The locking mechanism may be adjusted with an actuating member operatively connected to a bicycle gripping device. In some embodiments, the carrier may include a pair of wheel-binding devices each having a variable position along the base, to provide a more customizable fit for each particular bicycle. In some embodiments, a linkage may operatively connect the actuating member to the gripping device, with the linkage having a first portion of fixed length that extends from the gripping device to an anchor, and a second portion of variable length extending from the anchor to the actuating member.

Further aspects of the present disclosure are described in the following sections: (I) overview of an exemplary frame-gripping bicycle carrier, (II) coupling devices for attachment of the carrier to crossbars, (III) frame-gripping devices with a ratchet, and (IV) examples.

### I. Overview of an Exemplary Frame-Gripping Bicycle Carrier

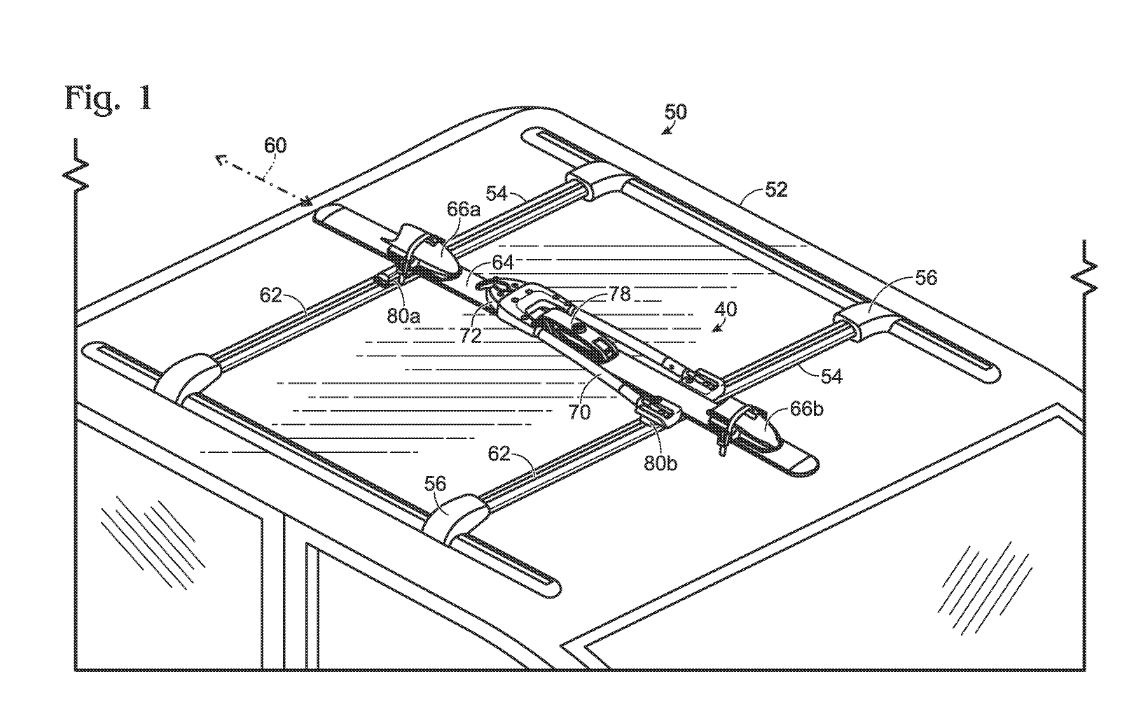

This section describes an exemplary vehicle rack system having a frame-gripping bicycle carrier 40, and methods of using the carrier to secure a bicycle or other article to a vehicle for transport; see FIGS. 1-22

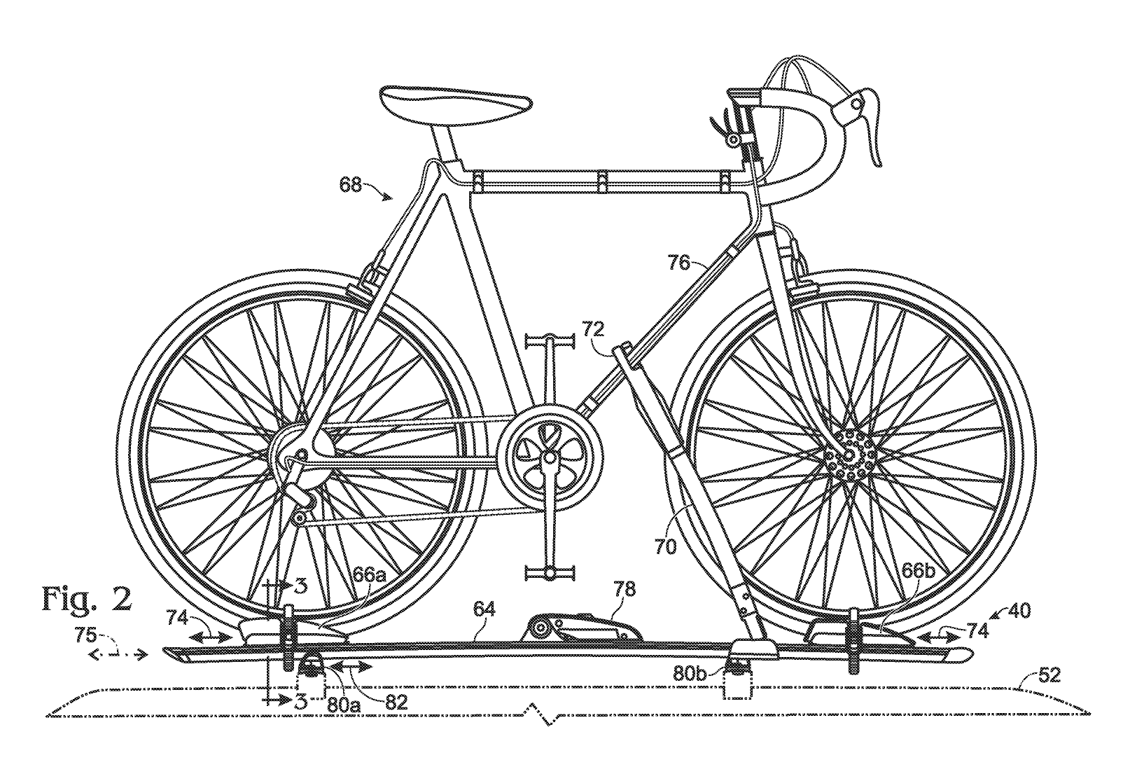

FIGS. 1 and 2 shows an exemplary vehicle rack system 50 mounted to the roof of a vehicle 52. Rack system 50 may include a frame or lower portion including a pair of crossbars 54, each of which may be attached to vehicle 52 with a pair of towers 56 (interchangeably termed feet). The rack system also may include a load carrier 40 to carry one or more articles adjacent the vehicle. For example, the load carrier may be bicycle carrier 40 mounted to the roof of the vehicle and supported by crossbars 54. In some embodiments, the load carrier may be mounted elsewhere on the vehicle, such behind the vehicle (e.g., a hitch-mounted load carrier), to the trunk of a vehicle, or the like.

Each crossbar 54 may be any elongate member or bar configured to be mounted to a vehicle, generally with the crossbar oriented transverse (e.g., orthogonal) to a direction of travel 60 of vehicle 52. The crossbar may be elevated from the roof of the vehicle by towers 56. The crossbar may have any suitable cross-sectional shape, such as round, rectangular (e.g., square), oval, ovoid, or the like. Each crossbar may or may not define one or more longitudinal slots 62, which are described in more detail in Section II.

Bicycle carrier 40 may include a base 64 and one or more bicycle-securing devices connected to and supported by the base. For example, in the present illustration, bicycle carrier 40 has a pair of wheel-binding devices 66a and 66b to secure the wheels of a bicycle 68 to the base (see FIGS. 1 and 2), and an arm 70 equipped with a frame-gripping device 72 to grip and secure the frame of bicycle 68 to base 64. In other embodiments, the bicycle-securing devices may include a fork mount and a wheel-binding device. An exemplary fork mount that may be suitable for the bicycle carrier disclosed herein is described in U.S. Patent Application Publication No. 2013/0062379 A1, published Mar. 14, 2013, which is incorporated herein by reference.

Each of the bicycle-securing devices may have a fixed or adjustable position with respect to the base (see FIG. 2). For example, one or both wheel-binding devices 66a and 66b may be slidable along the base, indicated by arrows at 74, substantially parallel to a long axis 75 defined by the base, to accommodate bicycles of different sizes each having a different wheelbase. Also or alternatively, arm 70 may be pivotally connected to the base at a first (proximal) end of the arm opposite a second (distal) end of the arm that includes frame-gripping device 72. The arm may be pivotable about a transverse axis that is orthogonal to long axis 75, to adjust the angle formed between the arm and the base. More particularly, the arm may be pivotable between a storage configuration (FIG. 1) and a use configuration (e.g., FIG. 2). In the storage configuration, the arm may be folded down to the base to extend along the base and position frame-gripping device 72 against and/or near the base, for example, with arm 70 substantially horizontal. In the use configuration, the arm may extend upwardly at an angle selected by the user, for example, to orient the arm perpendicular to any suitable frame portion, such as a down tube 76, of bicycle 68.

Bicycle carrier 40 may have an actuating member 78 (interchangeably termed an actuator or handle), such as a lever, to operate gripping device 72. Actuating member 78 may be configured to be manually engaged, such as grasped, and manipulated (interchangeably, operated or adjusted) to adjust gripping device 72. As described in more detail below, the actuating member may provide the benefits of an ergonomic design to simplify bicycle loading and unloading.

Carrier 40 may include one or more coupling devices or couplers 80a, 80b for mounting the carrier to rooftop crossbars 54. Each coupler, interchangeably termed a clamping device or docking device, may be any suitable device configured to secure bicycle carrier 40 to crossbar 54. For example, couplers 80a and 80b may have cleats configured to be received in longitudinal slot 62 of crossbar 54. In some examples, the coupler may be configured for clamping opposing external surface regions of a crossbar. In some examples, the coupler may be configured for adaptively clamping to differently shaped crossbars, including round, square, oval, and elliptical, among others. In some examples, the coupler may be configured for clamping an aerodynamically-shaped (e.g., at least generally ovoid) crossbar. Each coupler may be fixed or movable along base 64. For example, in the depicted embodiment (see FIG. 2), coupler 80b closer to arm 70 may be fixed, and coupler 80a farther from arm 70 may be adjustably positionable or slidable along the base, indicated by an arrow at 82, to accommodate different crossbar arrangements having different separation distances between the crossbars. After coupler 80a has been suitably positioned along the base, the coupler may be fixable to the base (independent of the crossbar) or may be held in place along the base by attaching couplers 80a, 80b to a pair of fixed crossbars.

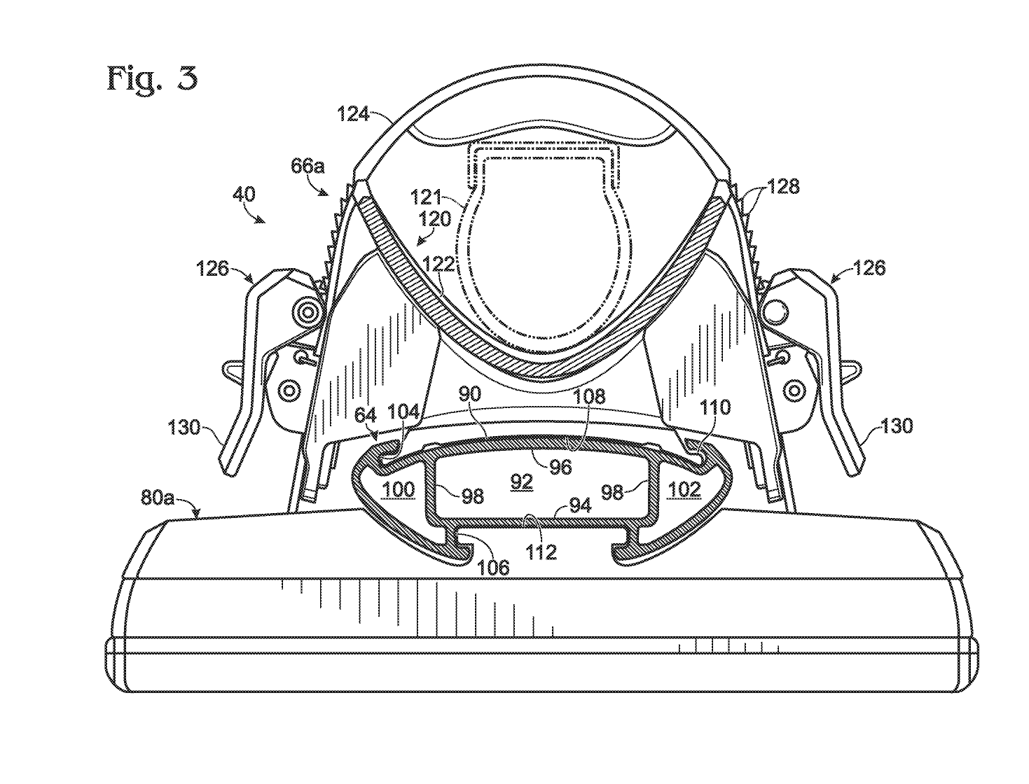

FIG. 3 shows a cross sectional view of bicycle carrier 40 taken through base 64 and wheel-binding device 66a. Base 64 interchangeably may be termed a rail or a body. The base may include a beam 90 as a structural member that extends a majority of the length of the base. The beam may define a longitudinal channel 92 (interchangeably termed a compartment or track), which may be enclosed or bounded between ends thereof by a floor or lower wall 94, a ceiling or upper wall 96, and opposing lateral side walls 98. The beam also may define additional enclosed, longitudinal channels 100, 102, which may, for example, be disposed laterally to channel 92. The beam further may define one or more open channels or tracks 104, 106 on an exterior thereof, such as above and below central enclosed channel 92. Each track may provide a receiver, such as a generally T-shaped receiver (and/or one or more grooves and/or ridges/flanges), to receive corresponding mating structure. For example, each wheel-binding device 66a and 66b may form a mounting region 108 including a pair of flanges 110 for placement into opposing lateral grooves of track 104. Similarly, coupler 80a (and/or 80b) may form a T-shaped mounting region 112 received in lower track 106. Each wheel-binding device may be slidably disposed in upper track 104, such as from an end thereof, and coupler 80a may be slidably disposed in lower track 106. Base 64 also may have end caps attached to the ends of beam 90, generally after the wheel-binding devices 66a, 66b and couplers 80a, 80b have been placed into tracks 104 and 106, to block the opposing ends of each track, thereby preventing each device from sliding off the end of the beam.

Beam 90 may have any suitable structure and composition. The beam may be substantially linear, optionally with a small amount of longitudinal curvature, or may be substantially curved longitudinally. The beam may have a uniform cross-sectional shape, or may vary in shape along its length. In some cases, the beam may be described as an extrusion. The beam may be formed of metal, such as aluminum or stainless steel, among others, or may be composed of a polymer (plastic), among others. The beam may be a single piece or be composed of two more pieces that are attached to each other (e.g., end-to-end, side-by-side, or the like).

Each wheel-binding device may form a cradle 120 (interchangeably termed a tray) to receive a lower region of a bicycle wheel 121. The cradle may define a transversely concave, upwardly facing contact surface 122 for the wheel and particularly a tire thereof. The wheel-binding device also may be equipped with a strap 124 that is secured to the tray or cradle with one or more retainers, such as buckles 126. The strap may be secured and/or tensioned by a ratchet formed collectively by teeth 128 of the strap and a pawl provided by each buckle 126. An actuator 130, such as a lever, may be operable to drive tightening of the strap and to release the strap.

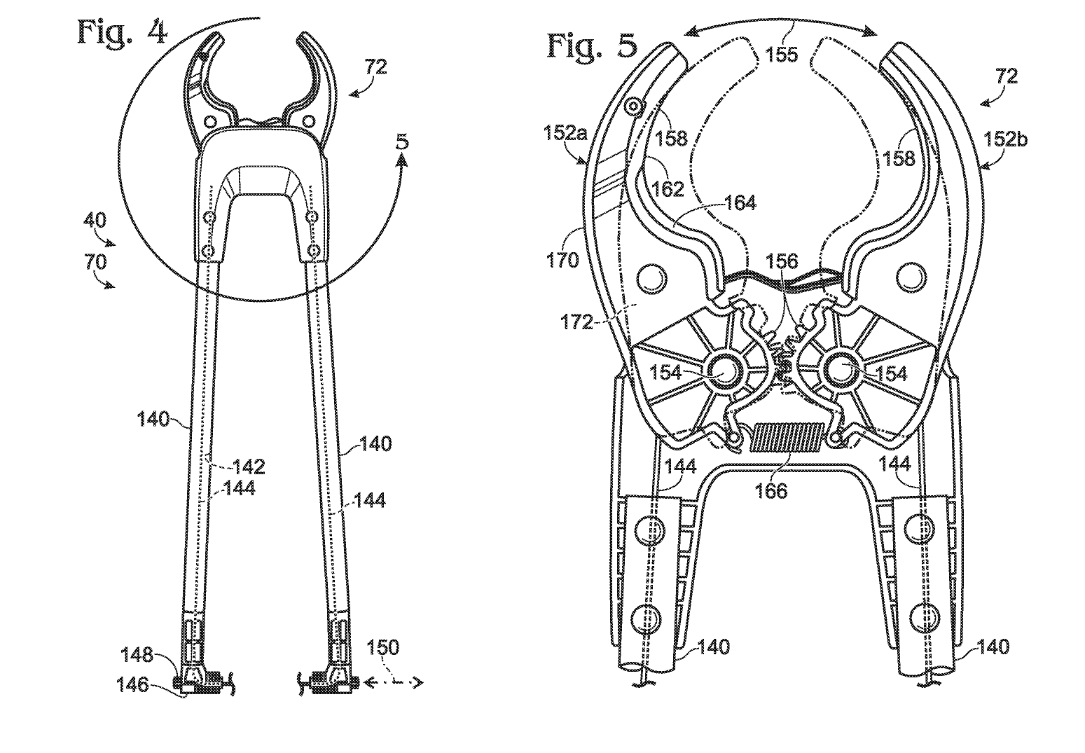

FIG. 4 shows arm 70 of carrier 40 in isolation, with gripping device 72 disposed at the distal end of the arm and ready to receive an article, such as a frame portion of a bicycle. The arm may have a hoop structure formed by a pair of laterally spaced-apart legs 140 each extending separately from gripping device 72 to the lower end of the arm. Each leg 140 may be hollow (a tube) to define a passage 142 along which a link member, such as at least one cable 144 or bar (e.g., a rod), may extend. The link member may extend along the leg, such as through the leg in passage 142, from the gripping device to the base of the carrier. Each leg may form an elbow or dogleg 146 at the lower end to direct cable 144 transversely into the base, such as toward a central vertical plane of the carrier. The lower end of each leg may be pivotally connected to base 64 at elbow 146 with a pivot pin 148 for pivotal motion about a horizontal, transverse pivot axis 150.

FIGS. 4 and 5 show further aspects of gripping device 72, which interchangeably may be described as a clamping device capable of compression parallel to pivot axis 150 of the arm (and/or the long axes of the crossbars). The gripping device may have a pair of claw members 152a, 152b interchangeably terming clamping members. Each claw member may be pivotally connected to a base of the gripping device with a pin 154, to define a pair of spaced pivot axes centered on respective pins 154. Pivotal motion of the claw members in opposite rotational directions, indicated by an arrow at 155, may be coupled and synchronized by respective sets of meshable cogs 156. The cogs may be formed on an inner side of each claw member near the lower end thereof, and arranged about each pivot axis.

Each claw member may have a curved or hooked structure such that the claw members converge toward their distal tips. The claw members collectively may form a pair of jaws 158 that opposingly engage a frame portion of a bicycle to secure the frame to the bicycle carrier. Each jaw may have a concave engagement surface or jaw face 162 that faces toward a receiving space defined between the jaws. The engagement surface may be formed by a jaw liner 164 that is softer and/or more flexible than other regions of the claw members, which effectively provides a padding to reduce damage to the bicycle frame. As described in more detail below, gripping device 72 may be adjusted to change the distance/gap between the jaws and/or the size of the receiving space between the jaws, namely, by closing the jaws (i.e., moving the jaws toward each other) and opening the jaws (i.e., moving the jaws away from each another (interchangeably termed apart)). In FIG. 5, a more open configuration of gripping device (and the jaws/claw members) is shown in solid lines, and a more closed configuration of the gripping device (and the jaws/claw members) is shown in phantom outline.

The gripping device may include at least one biasing member 166 that urges jaws 158 toward each other or away from each other. Each biasing member may be described interchangeably as a spring member and/or an elastic element. Here, biasing member 166 urges the jaws apart, toward an open or receiving configuration of the gripping device in which a frame portion of a bicycle may be placed between the jaws. To urge the jaws apart, the biasing member (e.g., a tension spring) may be connected to both claw members on an opposite side of each claw member's pivot axis from each respective jaw, as shown here, or the biasing member (e.g., a compression spring) may be connected on the same side of each pivot axis as the respective jaw. In other examples, the jaws may be urged apart (or together) by at least one torsion spring connected to at least one claw member.

Each claw member may be formed of only one or two or more materials. For example, the claw member have an outer body portion 170, which may be formed of plastic (a polymer), and a frame member 172, which may be formed of metal (e.g., a metal plate), fixed to the body portion.

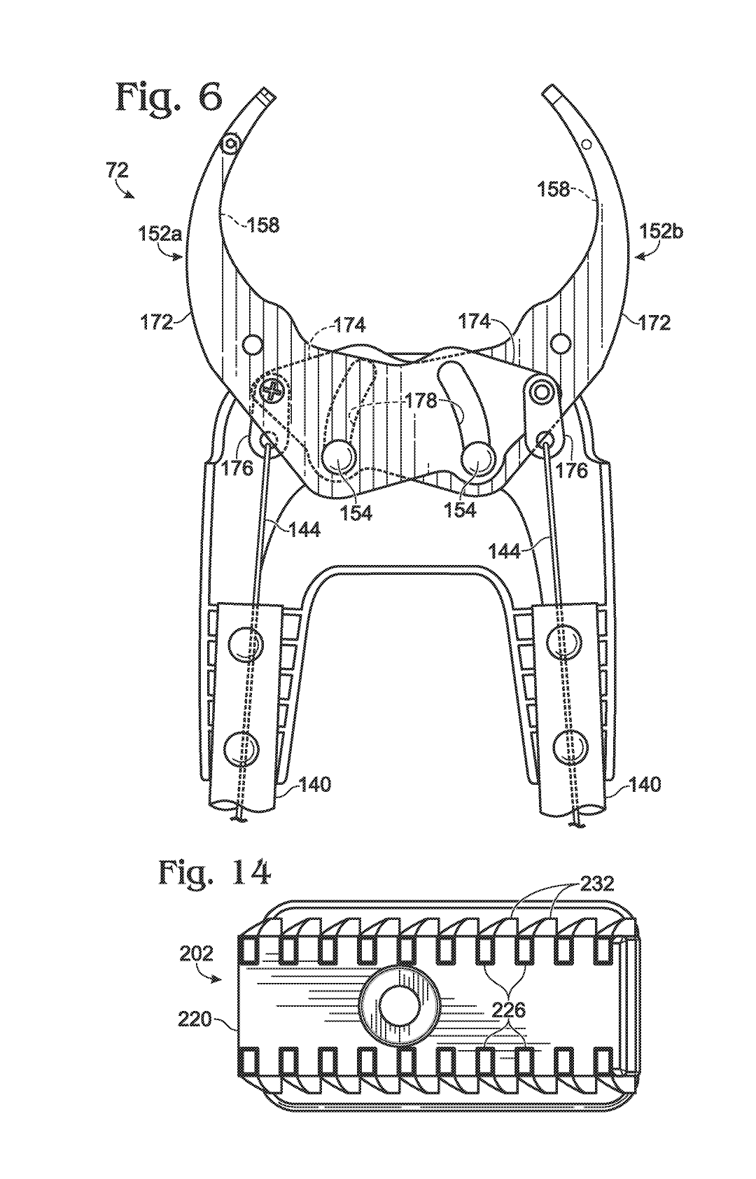

FIG. 6 shows gripping device 72 after removal of each body portion 170 (see FIG. 5) to reveal inner frame members 172. Each frame member may form a lever 174 to which an end of cable 144 may be connected via a tab 176. Pulling either cable causes the connected frame member 172 to pivot about the corresponding pivot axis of the claw member. For example, tensioning right cable 144 of FIG. 6 causes frame member 172 of left claw member 152a to pivot in a clockwise direction, which moves left jaw 158 toward right jaw 158. Tensioning left cable 144 of FIG. 6 produces a similar but counter pivotal movement of the other claw member 152b. Since the claw members may be rotationally coupled to each other by cogs 156 (see FIG. 5), tensioning either cable 144 causes synchronized pivotal motion of both claw members that closes the jaws. Accordingly, tensioning only one cable (or other link member) may be sufficient to close the jaws. The second cable (or other link member) may provide functional redundancy, such that the gripping device still can be operated if one of the cables breaks.

Each frame member 172 may define an arcuate slot 178 to receive pivot pin 154 for the other frame member. The slot allows each frame member to pivot while overlapped with the other frame member.

FIG. 7 shows a longitudinally central region of bicycle carrier 40, with arm 70 extending upwardly and jaws 158 of gripping device 72 closed (solid lines). The jaws may be opened, shown in phantom lines and indicated by an arrow at 179, by manipulation of actuating member 78. More particularly, in the depicted embodiment, actuating member 78 may be pivoted, such as about one-quarter turn, as shown in phantom lines and with an arrow at 180, from a closed to an open position, to adjust the jaws from a fully closed configuration (no bicycle frame) to a fully open configuration. The actuating member may extend along base 64 when the jaws are fully closed and/or locked against a bicycle frame (and the actuating member is in its closed position), and may extend transversely with respect to the base when the jaws are opened fully (and the actuating member is in an open position).

Actuating member 78 may be connected to base 64 separately from arm 70. Accordingly, the actuating member and the arm each may be movable (e.g., pivotable) independently of one another. The actuating member may be spaced along base 64, from an attachment site 181 of arm 70 to the base, by any suitable distance. For example, the actuating member may be mounted (e.g., pivotally) to the base at an attachment site 182 that is spaced from arm attachment site 181 by at least about one-fourth or one-half the length of the arm. The actuating member, in both the open or closed positions, may not overlap arm attachment site 181 longitudinally along the base, which allows easier access to and manipulation of the actuating member when the arm is in a bicycle-receiving orientation, without interference from the arm. In some embodiments, the actuating member may be configured to be received in an opening 184 defined by the arm (between legs 140) when the arm is folded down to its storage configuration (see FIG. 1).

Actuating member 78 may be centered transversely on base 64. The actuating member may be equally accessible from either lateral side of the bicycle carrier, allowing a user to more conveniently secure a bicycle to the carrier while standing on either side of the vehicle. In some cases, the actuating member may be at least substantially symmetrical with respect to a central vertical plane that bisects the base parallel to a long axis of the base.

Arm attachment site 181 may be provided by a bracket member 186 mounted to beam 90 of base 64. The bracket member may provide a mounting platform for the arm. The bracket member may be attached to an underside of beam 90 with fasteners. Fixed coupling device 80b may be attached to the underside of bracket member 186 and/or beam 90, and may or may not be configured to be removable from the base by the user.

FIG. 7 shows a portion of an exemplary linkage 188 that operatively connects actuating member 78 to gripping device 72. The linkage may include cables 144 following the exemplary paths presented here. Each cable may extend from gripping device 72, along the arm (e.g., through one of legs 140), into base 64, and along the base toward actuating member 78. For example, each cable may extend from an end of elbow 146 (see FIG. 4), through a lateral side wall (or other wall) of beam 90, and into the base. The cables may cross each other, indicated at 190, after the cables have exited arm 70, such as inside base 64 and/or beam 90. Each cable may have a minimum bend radius below which the cable tends to be damaged (e.g., kinked). Directing the cables on crossing paths allows the cables to avoid sharp turns that are below the minimum bend radius, which might otherwise occur, such as when the arm is folded down to the storage configuration. The cables may extend inside fixed guides 192, such as sleeves, where the cables cross (near crossing point 190), or otherwise change direction, to guide and hold each cable on a nonlinear path, and permit the cable to transmit tension without lateral slippage.

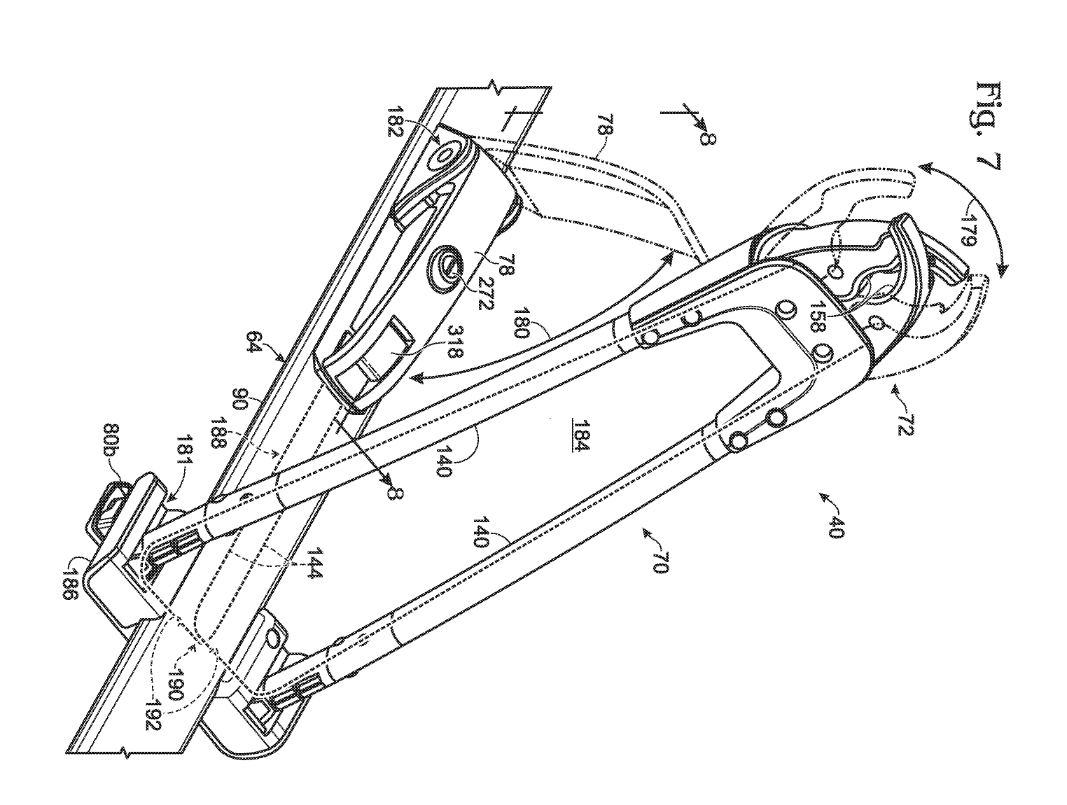

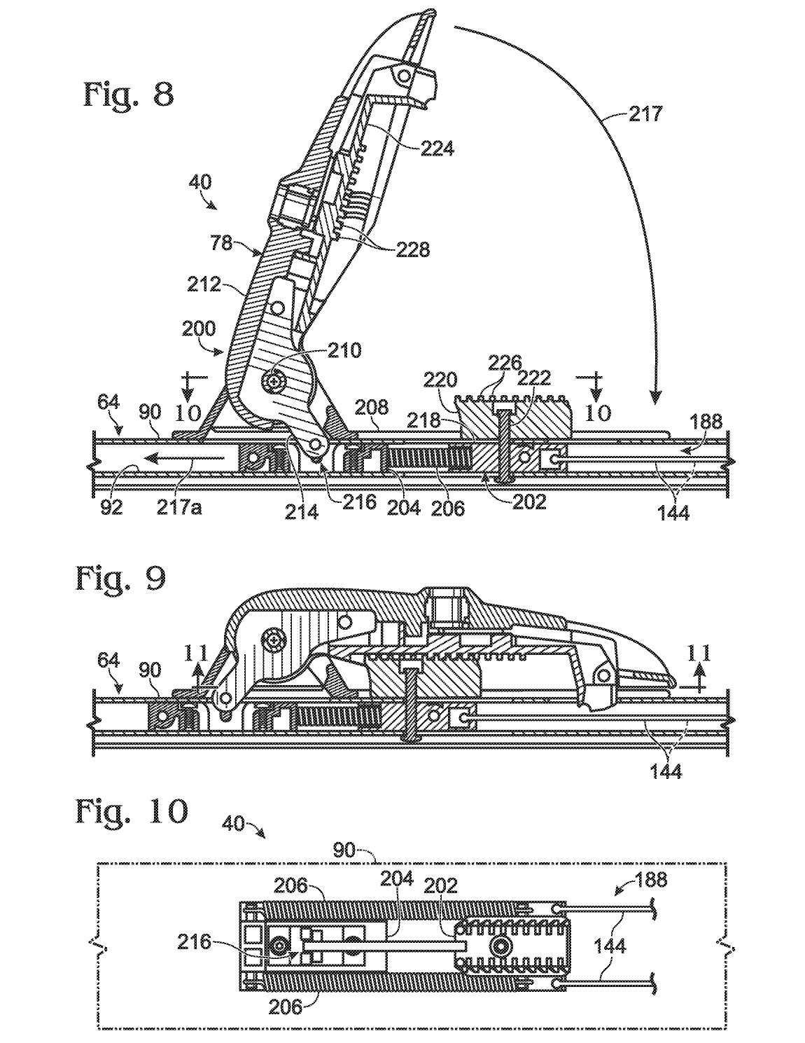

FIG. 8 shows a portion of an actuation assembly 200 that closes and opens the jaws of the gripping device. Assembly 200 may include actuating member 78 connected to linkage 188. Manipulation of actuating member 78 can adjust a tension on linkage 188 to operate the jaws of the gripping device, and then fix the tension to lock the jaws by isolating an elastic portion of the linkage from the gripping device.

Linkage 188 may have a first portion with a fixed length and a second portion having a variable length. The first portion may be formed by one or more link members arranged in series and/or in parallel, such as formed by a pair of cables 144 (e.g., see FIG. 7), among others. The first portion may extend from the gripping device to a proximal anchor 202, and the second portion may extend from the proximal anchor to actuating member 78. The first portion may be attached to proximal anchor 202 (e.g., an end of each cable secured to the proximal anchor).

The variable-length portion of the linkage may include proximal anchor 202 elastically connected to a distal anchor 204 with at least one elastic element 206. Each anchor may be movable, such as slidable parallel to a long axis of the base, optionally with at least a portion of each anchor inside the base, such as inside channel 92 defined by the base (also see FIG. 3). Each anchor interchangeably may be termed an anchor member, which may be movable and, optionally, fixable. For example, proximal anchor 202 may be fixed by engagement with actuating member 78, as described in more detail below. Elastic element 206 may, for example, include a tension spring and/or a coil spring, among others, which may be deformable to change its length and thus the distance between anchors 202, 204.

Actuating member 78 may be pivotally mounted to base 64 via a mounting portion 208 received in upper track 104 of beam 90 (e.g., see FIG. 3) and fixed to the beam with fasteners. Mounting portion 208 may form a pivotal connection 210 at which the actuating member can pivot. The actuating member may provide a pair of rigidly connected levers 212, 214, with pivotal connection 210 as the fulcrum. Lever 212 may be longer than lever 214 and may be grasped by hand to move the actuating member. Lever 212 may provide mechanical advantage for turning shorter lever 214. The shorter lever may have a pin-in-slot connection 216 with distal anchor 204. The angular position of actuating member 78 may determine the longitudinal position of distal anchor 204 along base, optionally for the whole range of pivotal motion of actuating member 78. In FIGS. 8 and 9, clockwise rotation of actuating member 78, indicated by an arrow at 217, drives leftward movement of distal anchor 204 along the base in a direction, indicated by an arrow at 217a, away from the proximal end of arm 70. As distal anchor 204 travels away from the proximal end of the arm, proximal anchor 202 also may travel in the same direction and at the same rate, until a threshold tension is reached that causes elastic element 206 to deform (e.g., stretch), as described in more detail below.

Proximal anchor 202 may include a lower portion 218 and an upper portion 220 connected by a fastener 222. Lower portion 218 may be disposed at least predominantly (e.g., completely) inside the base (e.g., in channel 92) and may provide an attachment site for the end of each cable 144. Upper portion 220 may be disposed at least predominantly outside the base (and/or channel 92 thereof) and may project upward from the base. Fastener 222 may extend through a longitudinal slot defined in the upper wall of channel 92, which allows the proximal anchor to move back and forth along the base.

The upper portion of proximal anchor 202 may be configured to be received in a recess 224 defined by a bottom side of lever 212. More particularly, lever 212 of actuating member 78 may be mated with upper portion 220 to fix the position of the proximal anchor. The lever may be mated in a plurality of interchangeable configurations that are offset from one another parallel to the long axis of the base, by increments determined by the spacing between adjacent teeth 226 formed on the top of proximal anchor 202 and/or corresponding adjacent teeth 228 formed in the ceiling of recess 224 of lever 212.

FIG. 10 shows a top view of selected aspects of linkage 188. Proximal and distal anchors 202, 204 may be connected by a pair of elastic elements 206 (e.g., coil springs), as shown here.

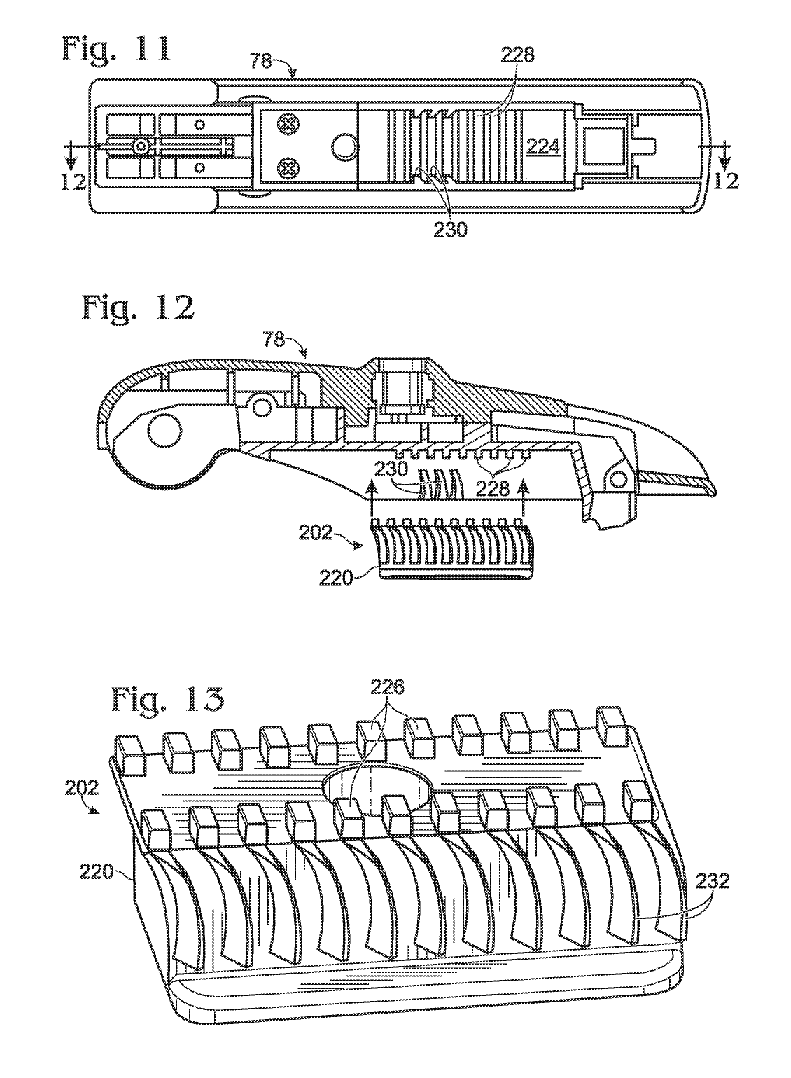

FIGS. 11 and 12 show actuating member 78 alone or aligned with upper portion 220 of proximal anchor 202, and FIGS. 13 and 14 show views of upper portion 220 in isolation. Meshed engagement of actuating member 78 with proximal anchor 202 may include meshed engagement of one or more curved lateral ridges or grooves 230 defined by one or both lateral side walls of recess 224, with corresponding curved ridges 232 (or grooves) defined by one or both opposing lateral side walls of the proximal anchor. The curved ridges/grooves may cause a small displacement of proximal anchor 202 along the base, due to camming action, as ridges 230 slide along ridges 232 when the actuating member is moved to a fully closed configuration. The camming action may produce additional tensioning of linkage 188, which in turn clamps gripping device 72 more tightly against the frame portion of the bicycle.

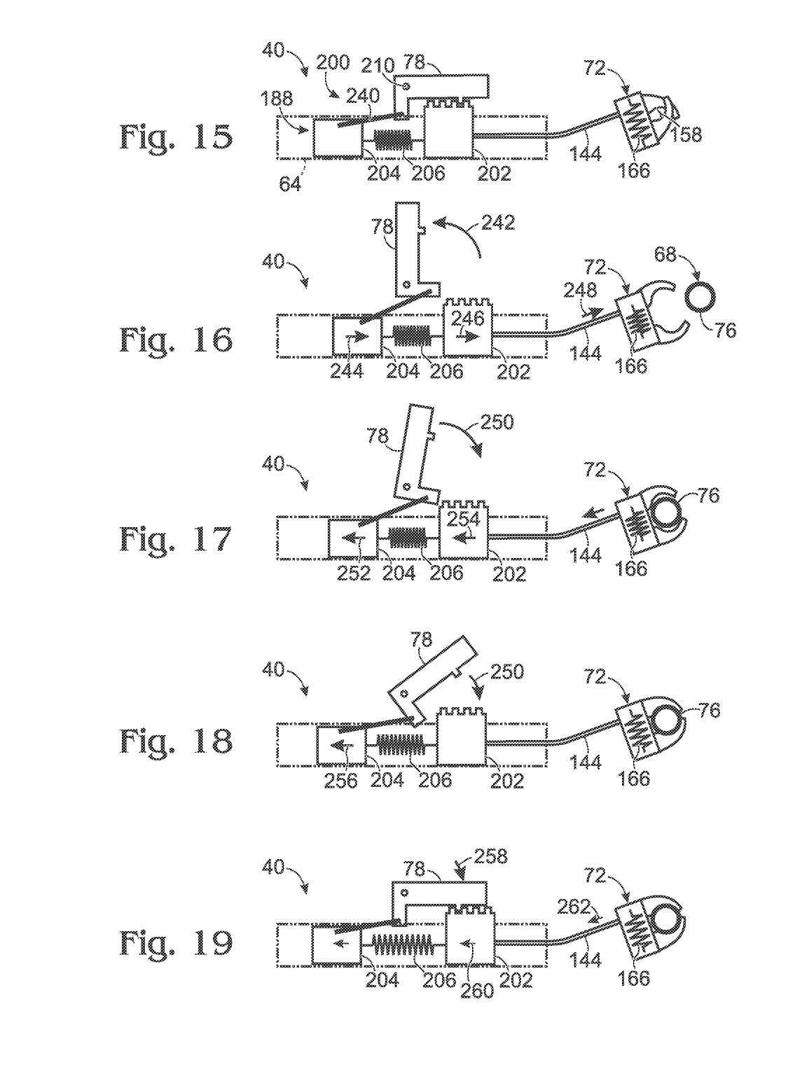

FIGS. 15-19 illustrate exemplary configurations that may be produced by manipulation of actuating member 78 of carrier 40 to clamp a bicycle to the carrier. Only selected aspects of the bicycle carrier, namely, actuation assembly 200 (actuating member 78 and linkage 188) and gripping device 72, are shown, and in a very schematic form. Base 64 is illustrated in phantom outline as a stationary reference, and pivot axis 210 of actuating member 78 is fixed with respect to the base. The remainder of arm 70 is not shown here and only one cable 144 is depicted. Positional coupling between actuating member 78 and distal anchor 204 (see FIG. 8) is indicated schematically by a bar 240. In other embodiments, a greater portion or all of linkage 188 and/or actuating member 78 may be included in and/or supported by the arm of the carrier.

FIG. 15 shows the carrier in an exemplary storage configuration. Proximal anchor 202 is locked in position by engagement with actuating member 78. Jaws 158 of gripping device 72 are fully closed and the gripping device is empty (no bicycle). Biasing element 166 is deformed (e.g., tensioned or stretched) from its lowest energy state, which biases the gripping device toward an open configuration. However, cable 144 is fixed by attachment to locked anchor 202, which prevents jaws 158 from opening. (In this configuration, while the proximal anchor remains locked, the jaws generally cannot open without a mechanical failure, such as breakage of both cables.) Elastic element 206 may be in its lowest energy state, namely, undeformed as shown. Alternatively, the elastic element already may be elastically deformed (e.g., stretched) from its lowest energy state in the storage configuration.

FIG. 16 shows the carrier after manipulation of actuating member 78 to unlock proximal anchor 202 and open the jaws of the gripping device. Rotation of the actuating member, indicated by arrow 242, drives distal anchor 204, indicated by arrow 244, toward proximal anchor 202, which causes the proximal anchor to travel a corresponding distance in the same direction, indicated by arrow 246. In some cases, the proximal anchor may travel a shorter distance than the distal anchor, such as if elastic element 206 is not in its lowest energy state in FIG. 15 (e.g., if the elastic element is stretched in FIG. 15). In any event, cable 144 travels toward gripping device 72, indicated by arrow 248, which allows biasing element 166 to open jaws 158 for receiving down tube 76 of bicycle 68.

FIG. 17 shows the carrier after down tube 76 has been placed between the jaws, and actuating member 78 has started on a return path, indicated by arrow 250, to proximal anchor 202. Distal anchor 204 is driven, indicated by arrow 252, in a direction away from proximal anchor 202. Since elastic element 206 may be more resistant to deformation than biasing element 166, travel of the distal anchor causes the proximal anchor to move an equal distance in the same direction, indicated by arrow 254 (without substantial deformation of elastic element 206), which begins to close the jaws around down tube 76.

FIG. 18 shows the carrier after further movement of actuating member 78 on return path 250. Biasing element 166 has been deformed to a higher energy state, and the jaws of the gripping device have moved into engagement with down tube 76, which stops travel of proximal anchor 202 (no arrow). However, further rotation of actuating member 78 continues to drive distal anchor 204 away from proximal anchor 202, indicated by arrow 256, which deforms elastic element 206 (e.g., stretches the elastic element) from its lowest energy state. As a result, the length of a variable-length portion of linkage 188 changes.

FIG. 19 shows the carrier with actuating member 78 returned to engagement with proximal anchor 202, to lock the anchor in position. Elastic element 206 is stretched more than in FIG. 18. Also, the elastic element is in a higher energy state than in FIG. 15 because proximal anchor 202 did not travel as far (as shown by the distinct, offset meshed configurations of the teeth in FIGS. 15 and 19). The amount of deformation of elastic element 206, and the magnitude of the change in the length of the variable-length portion of the linkage, may be determined by the size of the frame portion engaged by the bicycle. For example, if a wider (or narrower) down tube 76 is disposed between the jaws of the gripping device, travel of proximal anchor 202 will stop earlier (or later), and elastic element 206 will be deformed more (or less). Accordingly, elastic element 206 may function as a load governor, such that the actuation assembly self-adjusts to different sizes of bicycle frame tubes, to clamp each size of frame tube with about the same compressive force. The use of such a load governor can avoid clamping a wide down tube too tightly and a narrow down tube too loosely.

The seating motion of actuating member 78 into a fully seated position is indicated by arrow 258. This motion produces a camming action as the curved ridges/grooves of the actuating member travel along the curved ridges/grooves of the proximal anchor (see FIGS. 11-14), which moves proximal anchor 202 a short distance toward the distal anchor, indicated by arrow 260, resulting in an increased tension on cable 144, indicated by arrow 262, which tightens the jaws against the down tube of the bicycle.

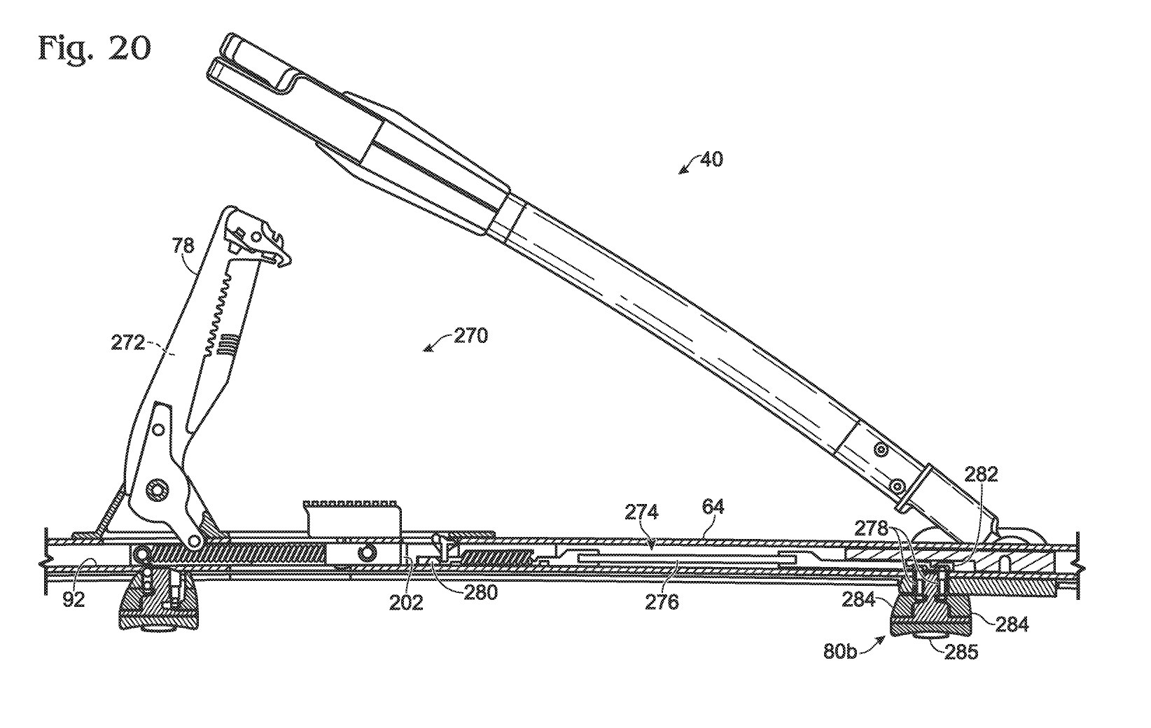

FIG. 20 shows an exemplary security system 270 that may be included in bicycle carrier 40. System 270 may include a security lock 272 that prevents unauthorized manipulation of actuating member 78 when the actuating member is engaged with proximal anchor 202 (also see FIG. 7). In other words, security lock 272 discourages theft of a gripped bicycle by preventing the frame-gripping device of the carrier from being opened by a would-be thief. The security lock may be key-operated. The security system also may include a coupler-locking mechanism 274 to prevent carrier 40 from being disengaged from the crossbar and removed from the vehicle rack system by an unauthorized person. Locking mechanism 274 may be adjustable by manipulation of actuating member 78, to permit or restrict adjustment of fixed coupler 80b for separation from the crossbar.

Locking mechanism 274 may include a movable pusher 276 (interchangeably terms a spanning member or reciprocating member) and one or more locking members, such as locking pins 278. Pusher 276 may be elongate and may extend along base 64 in channel 92, from a first end 280 to a second end 282. The pusher may be capable of reciprocating movement as a unit in base 64, parallel to the long axis of the base. Pusher 276 may be engaged with locking pins 278 at second end 282. Movement of the pusher may control the position of locking pins 278, namely, whether or not the pins project into coupler 80b to block manipulation of one or more coupler actuators 284. The actuators may be manipulable to adjust one or more clamp members, such as a crossbar-engaging cleat 285, between a crossbar-clamping configuration and a disengaged configuration.

FIG. 21 shows actuating member 78 nearly closed but not yet latched. Pusher 276 may have a biased position along the base produced by at least one biasing element 286 and a fixed member 288. Biasing element 286 may bear against pusher 276 at one end and fixed member 288 at the other end to urge the pusher leftward in FIG. 21 until the pusher is stopped by contact with fixed member 288 as shown. In this position of pusher 276, recesses 290 defined by second end 282 are aligned with locking pins 278, which allows the upwardly biased pins to travel upward in channel 92, out of openings 292 defined by coupler actuators 284. As a result, the locking pins do not obstruct operation of actuators 284, which allows the coupler to be placed in a disengaged or released configuration with respect to the adjacent crossbar, by movement of actuators 284, as indicated by arrows at 294 (also see Section II).

Actuating member 78 may have a projecting region 296 that operates a toggle member 298 of locking mechanism 274. The toggle member may be pivotally supported by fixed member 288 and may have a tab 300 that extends into an aperture 302 defined by first end 280 of pusher 276.

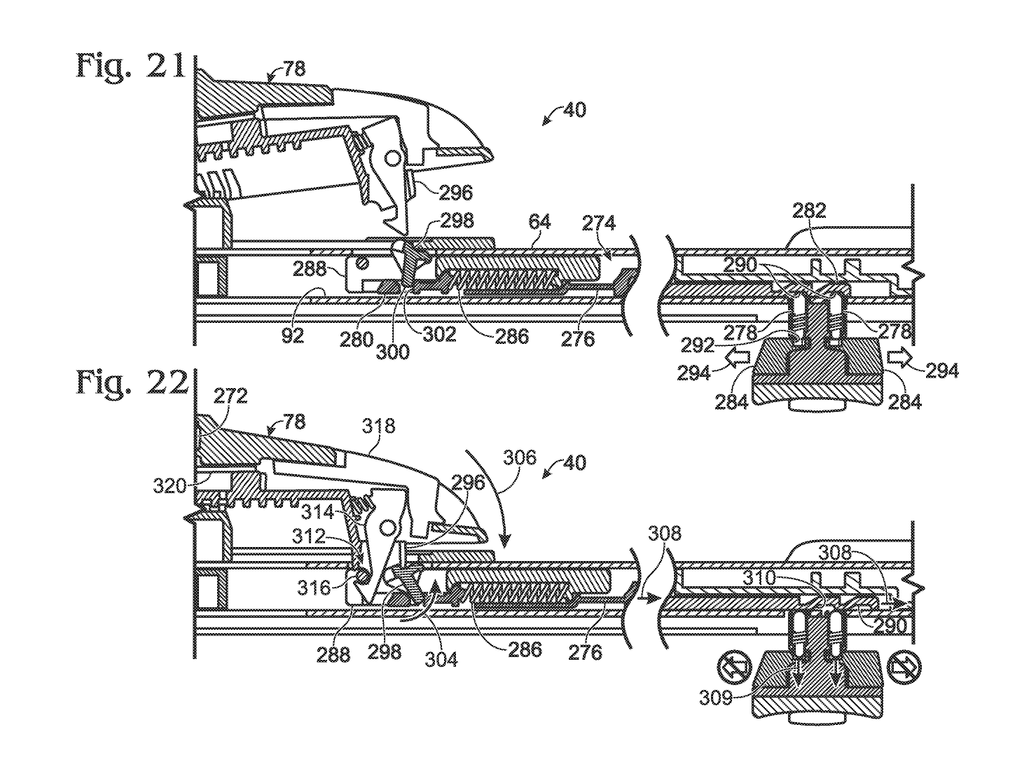

FIG. 22 shows actuating member 78 in a fully closed position. Pressure from projecting region 296 may cause toggle member 298 to pivot, indicated by an arrow at 304, as the actuating member is moved toward the fully closed position, indicated by an arrow at 306. Pivotal motion of the toggle member drives pusher 276 along the base, against the bias of elastic element 286, indicated by motion arrows at 308.

Motion of pusher 276 driven by closing the actuating member urges locking pins 278 downward, indicated by arrows at 309, into a locking position (compare FIGS. 21 and 22). The pins in the locking position prevent manipulation of coupler actuators 284. Each recess 290 of pusher 276 may provide an inclined surface or ramp 310 that produces a downward force on pins 278 as the pusher travels horizontally. Each pin may have a rounded end to facilitate smooth force transmission. Opening the actuating member, with travel in the reverse direction of arrow 306, removes the pressure on toggle member 298, which allows the spring-driven return of pusher 276 to the configuration of FIG. 21.

Actuating member 78 may be fastened with a latch 312 as the actuating member is closed. The latch may include a spring-biased hook member 314 that engages a pin 316 held by fixed member 288. Hook member 314 may be disengaged from pin 316 by manipulating (e.g., pressing) a release member 318, to unlatch the actuating member (also see FIG. 7).

Security lock 272 may be operable to restrict movement of release member 318. The security lock may be adjustable to position a stop member 320 in the path of the release member, to prevent the release member from being pressed for unfastening the actuating member. Accordingly, with the actuating member fully closed to engage the proximal anchor, fastened with latch 312, and locked by security lock 272, the bicycle and the carrier are resistant to theft. Further aspects of an exemplary security lock, latch, and release member that may be suitable for the bicycle carrier disclosed herein are described in U.S. Patent Application Publication No. 2013/0062379 A1, published Mar. 14, 2013, which is incorporated herein by reference.

### II. Coupling Devices for Attachment of the Carrier to Crossbars

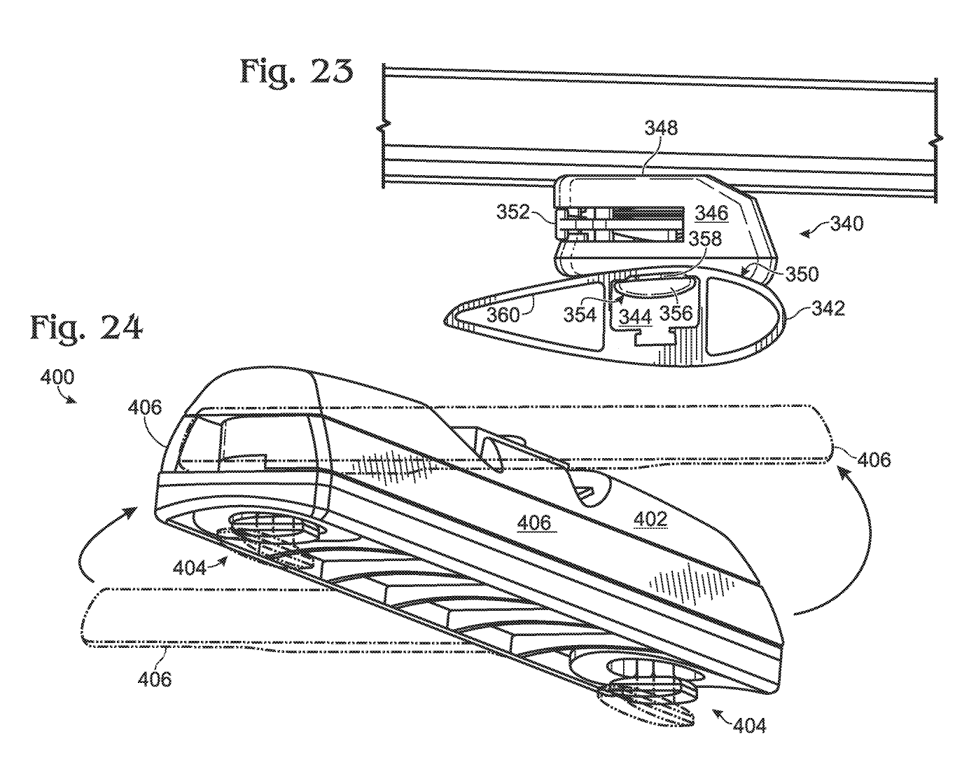

This section describes exemplary couplers (interchangeably termed coupling devices, clamping devices, or docks) for attachment of any of the bicycle carriers disclosed herein to a rack frame, such as crossbars thereof; See FIGS. 23-29. Each of the couplers disclosed in this Section may be suitable for use as coupler 80a or 80b, and the crossbar disclosed in this Section may be suitable for use as a crossbar 54 of vehicle rack system 50 (e.g., see FIGS. 1, 2, and 20-22, among others).

Turning to FIG. 23, an illustrative coupler is generally indicated at 340 and shown in a sectional elevation view mounted to an illustrative crossbar 342 having a T-slot 344. Coupler 340 may include a body 346, an upper mounting interface 348, a lower mounting interface 350, and one or more actuating members, such as operating levers 352. Upper mounting interface 348 may include one or more mounting structures such as threaded holes, threaded bolts, mounting apertures, slots, latches, clamps, and the like. In some examples, coupler 340 may be incorporated into a device or assembly such that upper mounting interface 344 is eliminated.

Lower mounting interface 350 may include one or more shaped cleats 354 (e.g., T-shaped) protruding from a lower surface of body 346. Each cleat 354 may include a head 356 and a shaft 358 operatively connected to a respective operating lever 352 such that pivoting the operating lever through 90 degrees causes cleat 354 to rotate 90 degrees around a long central axis of shaft 358, and also causes cleat 354 to translate a predetermined distance along the long axis of shaft 358.

In some examples, operation of the clamping mechanism may be described beginning with coupler 340 clamped to crossbar 342 as shown in FIG. 23. Pivotal movement of operating lever 352 away from body 346 by 90 degrees causes cleat 354 to rotate to place a long axis of head 356 into alignment with a long axis of T-slot 344. This rotation allows head 356 to pass unimpeded through the mouth or opening of T-slot 344. Pivoting operating lever 352 in this manner also causes head 356 of cleat 354 to move away from body 346. The net effect of this rotation and translation may be to disengage cleat 354 from crossbar 342, because a wall 360 of crossbar 354 will no longer be clamped between body 346 and head 356. Conversely, pivoting operating lever 352 closed, or 90 degrees back toward body 346 may result in clamping of wall 360 by cleat 354 as head 356 moves toward body 346 and rotates to place a long axis of head 356 ninety degrees out of alignment with a long axis of T-slot 344.

FIGS. 24-27 show another example of a coupler such as coupler 300. Specifically, opposing-lever coupler 400 may include a body 402, two cleat assemblies 404, and two actuators, such as operating levers 406. FIG. 24 shows an isometric view of coupler 400. The pivoting of operating levers 406 is illustrated in phantom lines as they pivot outward from opposite sides of body 402. FIG. 24 also shows the resulting rotation and translation of the cleats as levers 406 are pivoted outward.

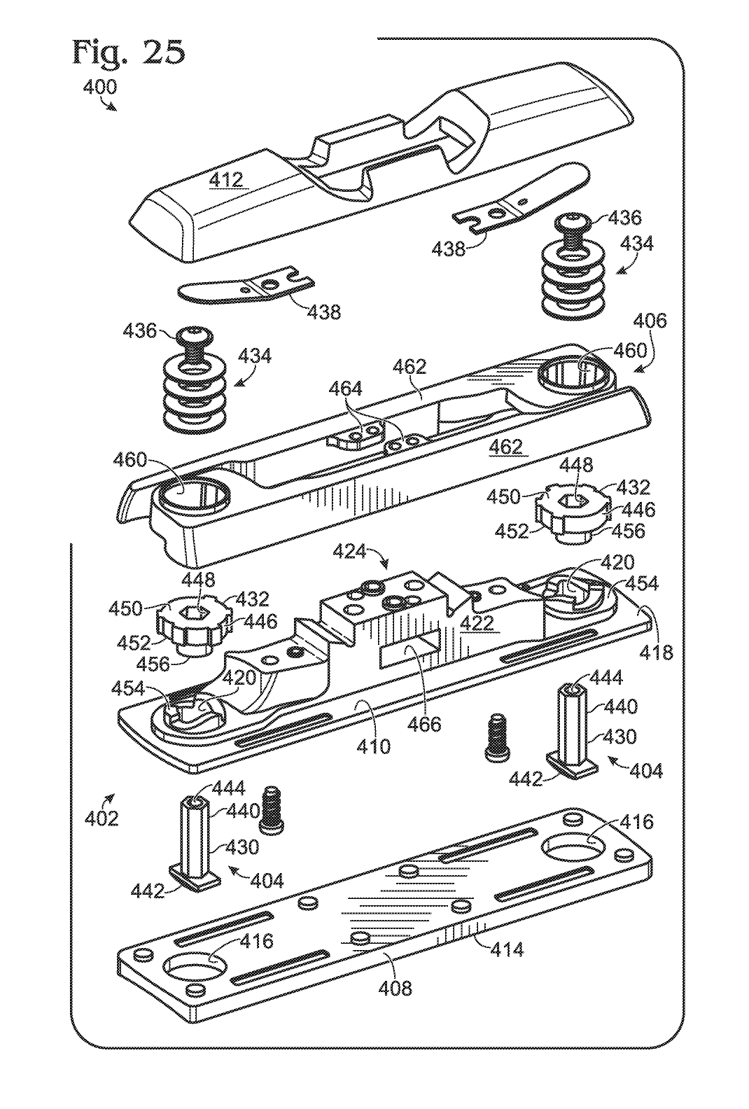

As best seen in the exploded view of FIG. 25, body 402 may include a base pad 408, a base 410, and a cover 412. Base pad 408 may include a mounting surface 414 shaped to conform to a surface of a crossbar, and two apertures 416 each sized to allow free passage of a cleat of cleat assemblies 406. Base 410 may be attached to base pad 408, and may be any suitable structure configured to provide various mounting points, apertures, and control surfaces for attaching the remaining components of coupler 400. In some examples, base 410 may include an outer flange 418 that may be friction fit to base pad 408. Base 410 may include two apertures 420 for attaching cleat assemblies 404, the apertures being disposed on either side of a central block structure 422 that may include an upper surface 424 configured for mounting external components such as a carrier rail and/or fork mount. Cover 412 may be any suitable upper rigid casing or cap configured to cover at least part of base 410 and to provide protection for internal components as well as to provide aesthetic appeal and improved aerodynamics.

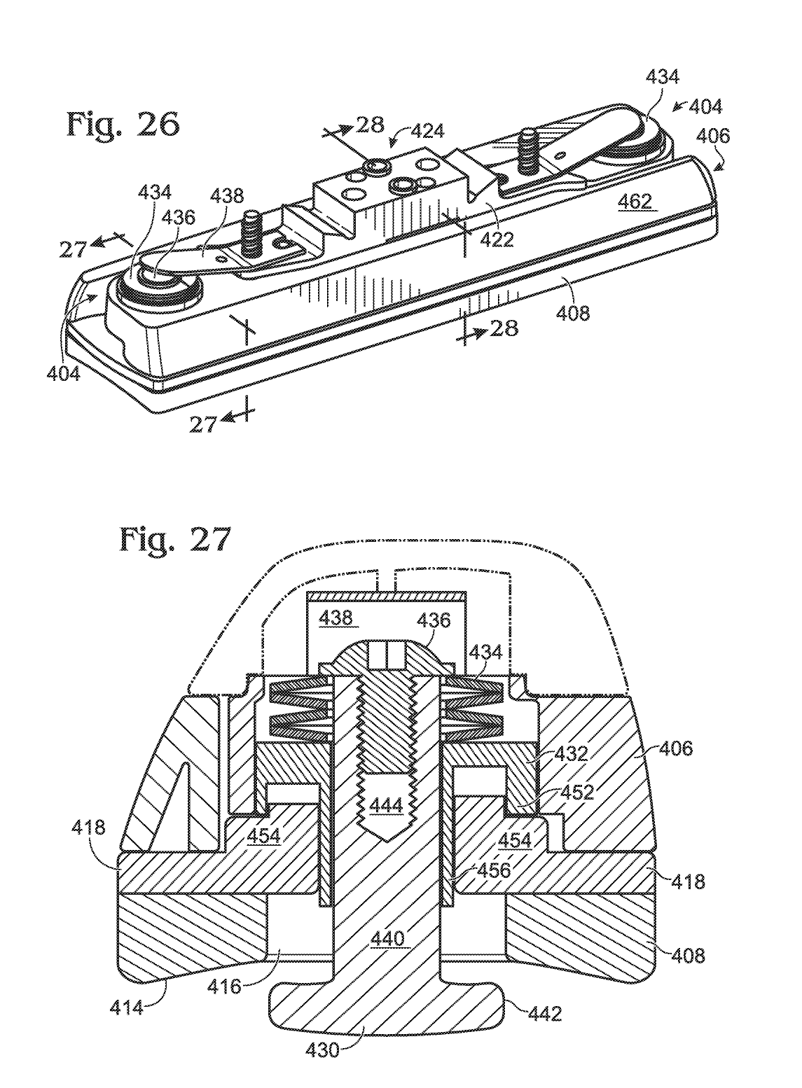

Each cleat assembly 404 may include components configured to convert the quarter-turn rotation of an operating lever into simultaneous axial rotation and axial translation of a cleat. With continuing reference to FIG. 25, and as additionally shown at least partially in FIGS. 26-28, each cleat assembly 404 may include a cleat 430, a cam follower 432, a biasing assembly 434, mounting hardware 436, and a preload member 438.

Each cleat 430 may be any rigid member having a shaft with an enlarged head portion at a distal end, configured to pass through the opening of a standard T-slot in one orientation and to be unable to pass through the opening in an orientation 90-degrees from the first orientation. For example, a cleat may have a “J” or an “L” or an inverted “T” shape. In the example shown in FIG. 25, cleat 430 may have an inverted “T” shape, with a hexagonal-cross-section shaft 440 and a cleat head 442 that extends outward on each side of shaft 440 at a distal end. Shaft 440 may have a threaded axial hole 444 formed in a proximal end for receiving mounting hardware 436.

Each cam follower 432 may be any suitable structure configured to facilitate attachment of an operating lever to a cleat, and to provide a cam follower surface for producing axial translation of the cleat. In the example shown in FIG. 25, cam follower 432 may include a roughly cylindrical upper portion 446 having a keyed or gear-like perimeter for mating in a friction fit with a correspondingly shaped aperture in an operating lever. Cam follower 432 may also include a hexagonal axial aperture 448 for receiving cleat shaft 440.

Upper portion 446 may also include a flat upper surface 450, and a lower cam follower surface 452 for interfacing with a raised cam surface 454 located around the upper circumference of aperture 420 on base 410. Raised cam surface 454 may include four portions, each covering 90 degrees of the circumference, each portion curving normally away from the base flange over the 90 degrees.

Cam follower 432 may also include a sleeve 456 protruding downward from upper portion 446 and sized to fit snugly within aperture 420 when the cam follower surface 452 is in contact with cam surface 454. Downward is used in this sense as away from cover 412 and toward base pad 408. From this description, and from the drawings, it should be understood that sleeve 456 of cam follower 432 may be inserted into aperture 420, and that subsequent rotation of cam follower 432 within the aperture will cause the cam follower to move axially in and out of the aperture due to the interaction of the cam and cam follower surfaces.

Together, biasing assembly 434 and mounting hardware 436 may flexibly secure cleat 430 to cam follower 432. Biasing assembly 434 may include any suitable spring-like structure configured to provide a flexible interface between mounting hardware 436 and upper flat surface 450 of cam follower 432. Mounting hardware 436 may be any suitable mechanical connector for connecting cleat shaft 440 to biasing assembly 434. In the example shown in FIG. 25, mounting hardware 436 is a bolt or screw inserted into threaded hole 444 in cleat shaft 440. In this example, biasing assembly 434 is a series of four Belleville washers, arranged in alternating fashion to form a spring between the head of mounting hardware 436 and flat top surface 450 of cam follower 432. Accordingly, cleat 430 is attached to cam follower 432 and will rotate with the cam follower because the hexagonal shaft of the cleat is confined within the hexagonal aperture in the cam follower. However, cleat 430 maintains a degree of axial freedom due to the flexible nature of the attachment, and can slide up and down within the cam follower against the spring force of the washer stack.

Preload member 438 may be any suitable structure configured to flexibly restrain cleat 430 from upward axial movement. Upward is used in this sense as away from base pad 408 and toward cover 412. In the example shown in FIG. 25, preload member 438 may be a leaf spring or other spring-like strip of metal secured to base 410 at one end and resting atop mounting hardware 436 at the other end.

Operating levers 406 may each be an elongated handle pivotable at one end and attached to a cleat assembly such that pivoting the lever also rotates the cleat assembly. In the example shown in FIG. 25, each operating lever 406 includes a keyed mounting hole 460, lever arm 462, and tab 464. Keyed mounting hole 460 may be an aperture in a proximal end of operating lever 406, with an inner perimeter shaped to provide a friction fit with the gear-like outer perimeter of upper portion 436 of cam follower 432. Other mounting methods may be possible, such as bolting, adhering, or otherwise affixing the operating lever to the cam follower. Lever arm 462 may be any suitable handle configured to facilitate user manipulation. In this example, lever arm 462 may be substantially the same length as base 410, and an outer surface of each lever arm 462 may form a portion of the outer surface of coupler 400. Tab 464 may protrude from an inner surface of lever arm 462, and may provide an interface for a detent mechanism and/or locking pins (not shown) to keep the lever arm in position adjacent to body 402. Tab 464 may fit into a corresponding aperture or recess 466 in base 410 when operating lever 406 is pivoted fully against the base.

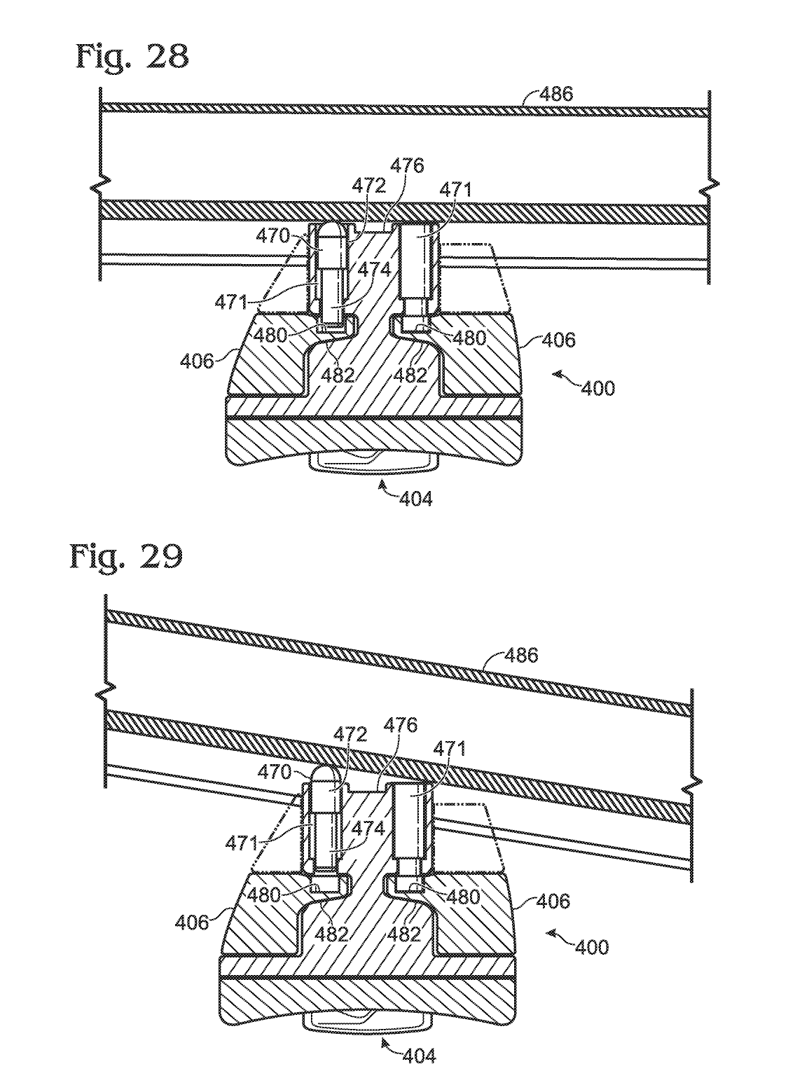

FIGS. 28 and 29 are sectional views of an illustrative locking pin mechanism for use in coupler 400. One or more through-holes may be formed in the upper mounting interface of the central block structure the coupler, with a hole passing through the block and aligning with a recess in the tab of an operating lever when the lever is fully pivoted against the body of the coupler. A shaped, spring-biased locking pin may be placed into the hole. An upper portion of the locking pin may protrude above the mounting surface due to spring biasing, and the locking pin may be sized such that applying downward force to overcome the biasing causes a lower portion to engage the recess in the tab of the operating lever, thereby preventing repositioning of the operating lever.

As depicted in FIGS. 28 and 29, a locking pin 470 may be an elongated cylindrical member having an upper portion 472 with a rounded end and a larger diameter than a lower portion 474. A spring or other biasing device may be used to bias locking pin 470 in a position in one of one or more locking pin holes 471 where the rounded head of upper portion 472 protrudes above a mounting surface 476 of a coupler 478. In this position, a lower end of lower portion 474 may remain disengaged from a recess 480 in a tab 482 of an operating lever 484, as shown in FIG. 29.

FIG. 28 shows an external component, in this case a bicycle carrier rail or beam 486, mounted on mounting surface 476 and depressing locking pin 470 into recess 480. FIG. 29 illustrates that tilting the rail greater than approximately 15 degrees may allow locking pin 470 to disengage from recess 480 and thereby unlock lever 484. As a security measure, an end of rail 480 may be operatively locked to a crossbar (such as with coupler 80b; see FIGS. 20-22), such that the end must be freed before the rail may be tilted as described. Any suitable structure may be used to provide locking force to pins such as locking pin 470. In some examples, portions of other components such as fork attachments or other mounting devices may be utilized to interact with a locking pin or pins. In some examples, the portions used may be device locks themselves, thereby simultaneously locking the device to the coupler and the coupler to a rail.

### III. Frame-Gripping Devices with a Ratchet

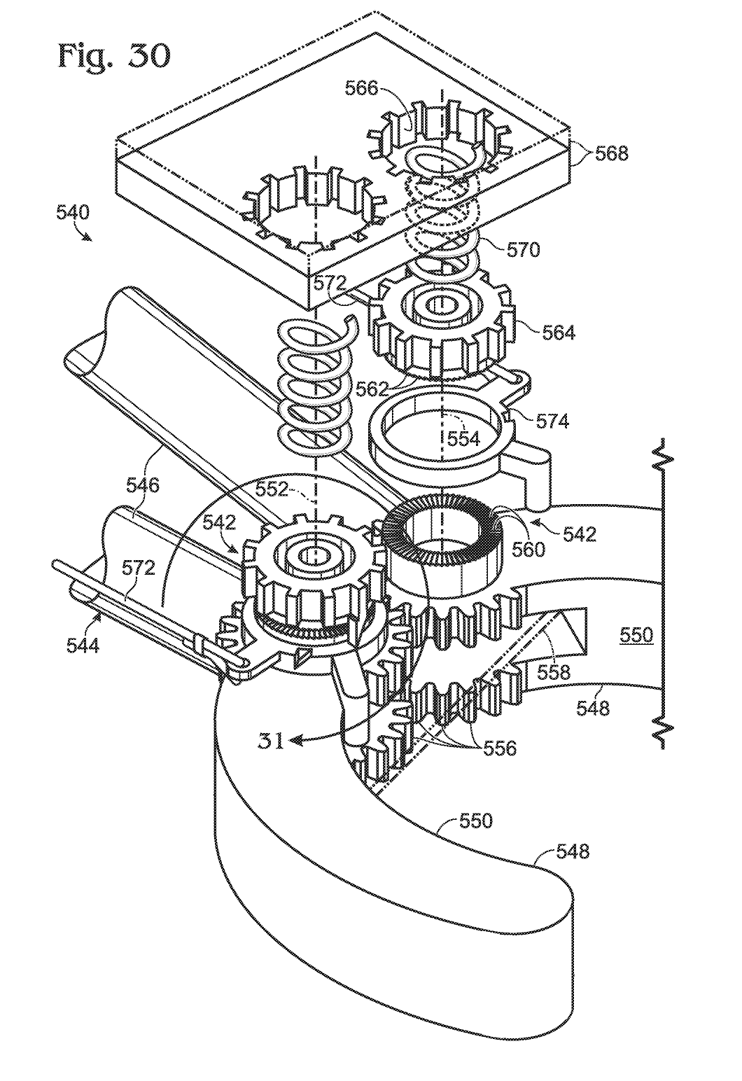

This section describes other exemplary frame-gripping or clamping devices each including one or more ratchets to restrict opening of the jaws; see FIGS. 30-34. Any suitable aspects of the frame-gripping devices disclosed in this section may be combined with each other and/or with any of the elements, aspects, or features of other carriers and/or rack systems of the present disclosure.

FIG. 30 shows an exemplary frame-gripping device 540 with at least one or a pair of ratchets 542. Gripping device 540 may be located at the distal end of an arm 544 of a bicycle carrier, with the arm optionally having a pair of legs 546. The gripping device may include a pair of claw members 548 (interchangeably termed clamping members) each forming a respective jaw 550. The claw members may be pivotal about respective pivot axes 552, 554 and pivotally coupled by cogs 556. Accordingly, the gripping device may be configured with only one ratchet.

The jaws of the gripping device may be biased toward a closed configuration by at least one biasing element 558. In exemplary embodiments, the biasing element may be any suitable type of spring such as a constant-force spring, a tension spring, a compression spring, or a torsion spring, among others.

Each ratchet 542 may be configured to permit pivotal motion of the corresponding claw member in one direction of rotation (to close the jaws), and to restrict pivotal motion in the opposite direction of rotation (to open the jaws). The ratchet may be formed by a first set of teeth 560 defined by a claw member and meshable with a second set of teeth 562 defined by a pawl member 564. The teeth of each set may be arranged around the pivot axis 552 or 554 of the claw member. The ratchets may be configured to be meshed in alternation, due to an angular offset of the ratchets from each other. The angular offset may be about one-half the angular distance between adjacent teeth of a set.

Each pawl member 564 may be movable along the corresponding pivot axis 552 or 554 but not pivotable about the pivot axis. For example, the pawl member may be disposed in a recess 566 defined by a fixed portion 568 of the gripping device, with the pawl member keyed to the recess (e.g., splined) such that the pawl member can slide along the pivot axis but cannot rotate. A biasing element 570 may urge the pawl member toward the claw member for engagement with the teeth of the claw member.

Each claw member may be operatively connected to a link member 572, such as a rod or a cable. (If only one ratchet is used, then only one link member may be needed.) The link member may be attached to a cam member 574 that pivots about one of pivot axes 552 or 554.

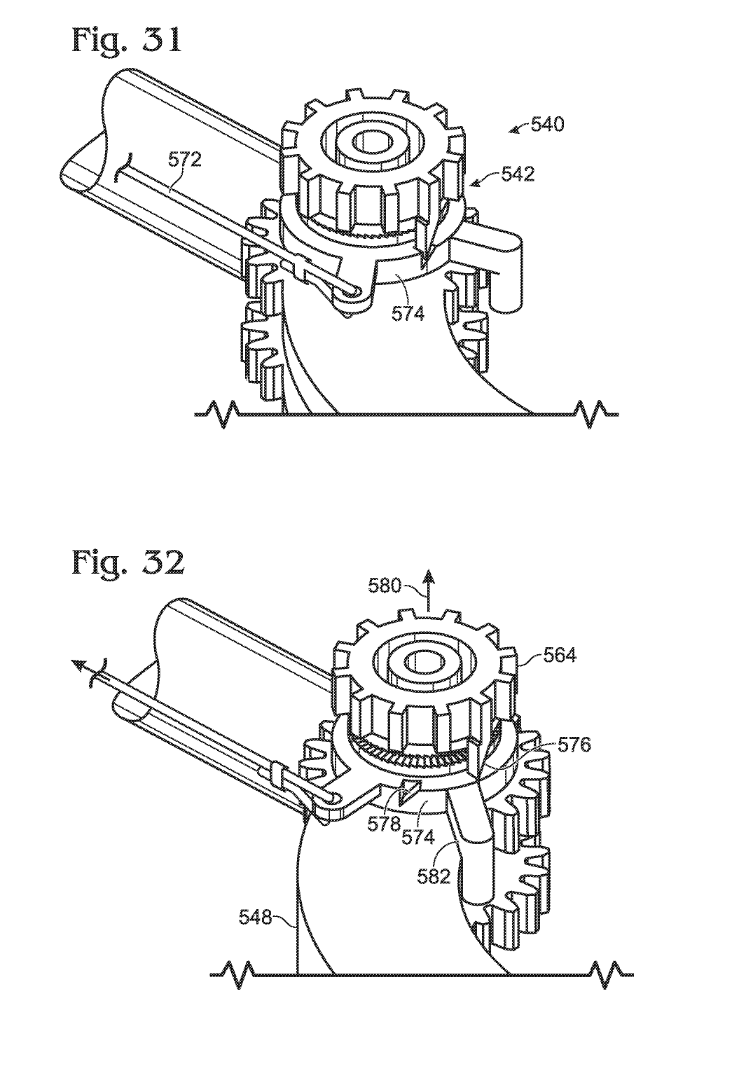

FIG. 31 shows ratchet 542 in a meshed configuration before application of tension with link member 572.

Cam member 574 may be pivoted by applying tension to link member 572 (see FIG. 32). As the cam member pivots, a cam follower 576 of pawl member 564 may be urged out of a recess 578 defined by the cam member, to disengage the ratchet, indicated by a motion arrow at 580. Once the ratchet is disengaged, the claw member is no longer blocked from pivoting in an opening direction. Further rotation of the cam member may cause a lever 582 thereof to engage claw member 548 and pivot the claw member in the opening direction.

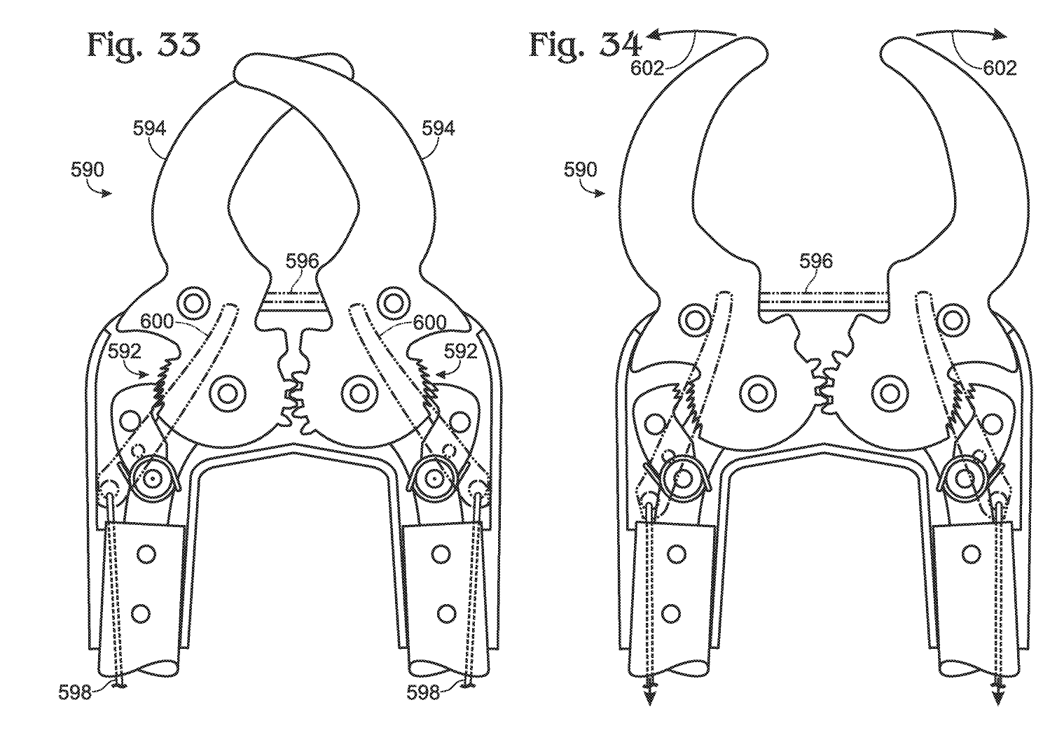

FIGS. 33 and 34 show another exemplary gripping device 590 having ratchets 592 that restrict movement of claw members 594. The jaws of the gripping device may be biased toward a closed configuration by at least one biasing element 596. Ratchets 592 may mesh in alternation, as described above for ratchets 542 (see FIGS. 30-32). Tension on each link member 598 may pivot a lever member 600 that disengages the associated ratchet and then pivots the claw member in an opening direction, indicated by motion arrows at 602 in FIG. 34.

### IV. Examples

This section describes exemplary embodiments of the present disclosure as a series of indexed paragraphs.

A1. A load carrier mountable to a vehicle and configured to hold a bicycle above the roof of the vehicle, comprising: (i) a base; (ii) at least one wheel-binding device to secure at least one wheel of a bicycle to the base; (iii) an arm having a first end connected to the base and a second end including a gripping device having a pair of jaws to grip a frame portion of the bicycle; and (iv) an actuating member operatively connected to the gripping device such that manipulation of the actuating member closes the jaws to grip the frame portion and opens the jaws to release the frame portion.

A2. The load carrier of paragraph A1, wherein the actuating member and the arm are mounted to the base separately from each other.

A3. The load carrier of paragraph A1 or A2, wherein the first end of the arm and the actuating member are mounted to the base at respective sites that are spaced from each other along the base.

A4. The load carrier of any of paragraphs A1 to A3, wherein the at least one wheel-binding device includes a pair of wheel-binding devices each adjustably positionable along the base independently of one another.

A5. The load carrier of any of paragraphs A1 to A4, wherein the arm has a pair of legs arranged laterally of one another.

A6. The load carrier of paragraph A5, wherein each leg includes a tube.

A7. The load carrier of any of paragraphs A1 to A6, wherein the base defines a longitudinal channel, further comprising a linkage that operatively connects the actuating member to the gripping device, a portion of the linkage being disposed in and extending along the channel.

A8. The load carrier of paragraph A7, wherein the linkage includes a cable that extends along the channel and into the arm.

A9. The load carrier of paragraph A7 or A8, wherein the linkage has opposing ends and includes a pair of cables that cross one another intermediate the opposing ends.

A10. The load carrier of paragraph A9, wherein the pair of cables cross one another in the base.

A11. The load carrier of paragraph A9 or A10, wherein the arm includes a pair of legs, and wherein the pair of cables cross one another in a portion of the linkage extending from the legs to the actuating member.

A12. The load carrier of any of paragraphs A1 to A11, further comprising a linkage that operatively connects the actuating member to the gripping device, the linkage including an anchor member disposed in the base and slidable parallel to a long axis of the base.

A13. The load carrier of paragraph A12, wherein the linkage includes at least one elastic element and at least one cable, and wherein the at least one elastic element and the at least one cable are interconnected by the anchor member.

A14. The load carrier of paragraph A12 or A13, wherein the actuating member is engageable with the anchor member such that load transmission between the at least one cable and the at least one elastic element is blocked.

A15. The load carrier of any of paragraphs A12 to A14, wherein the linkage includes a pair of anchor members having an elastic connection to each other.

A16. The load carrier of any of paragraphs A1 to A15, wherein the arm is pivotally connected to the base.

B1. A load carrier mountable to a vehicle and configured to hold a bicycle in a fixed position above the roof of the vehicle, comprising: (i) a base; (ii) at least one wheel-binding device to secure at least one wheel of a bicycle to the base; (iii) an arm having a first end connected to the base and a second end including a gripping device having a pair of jaws to grip a frame portion of the bicycle; (iv) an actuating member operable to close the jaws to grip the frame portion and to open the jaws to release the frame portion; and (v) a linkage that operatively connects the actuating member to the gripping device, the linkage extending in a longitudinal channel defined by the base and into and along the arm to the gripping device.

B2. The load carrier of paragraph B1, wherein the linkage includes a cable that extends along the channel and into the arm.

B3. The load carrier of paragraph B1 or B2, wherein the linkage has opposing ends and includes a pair of cables that cross one another intermediate the opposing ends.

B4. The load carrier of paragraph B3, wherein the pair of cables cross one another in the base.

B5. The load carrier of any of paragraphs B1 to B4, wherein the linkage includes a pair of anchor members disposed in the base and having an elastic connection to each other.

B6. The load carrier of paragraph B5, wherein each anchor member is movable along the base.

C1. A load carrier mountable to a vehicle and configured to hold a bicycle in a fixed position above the roof of the vehicle, comprising: (i) a base; (ii) at least one wheel-binding device to secure at least one wheel of a bicycle to the base; (iii) an arm having a first end connected to the base and a second end including a gripping device having a pair of jaws to grip a frame portion of the bicycle and a biasing member that urges the jaws apart; (iv) an actuating member; and (v) a linkage operatively connecting the actuating member to the gripping device such that manipulation of the actuating member opens and closes the jaws via the linkage, the linkage including a first portion extending from the gripping device to an anchor member that is engageable with the actuating member to fix the anchor member and a second portion extending from the anchor member to the actuating member and having a variable length.

C2. The load carrier of paragraph C1, wherein the second portion includes an elastic element that stretches in response to the actuating member being adjusted from a first position at which the jaws opposingly engage the frame portion of the bicycle to a second position that fixes the anchor member.

C3. The load carrier of paragraph C1 or C2, wherein the anchor member travels along the base when the actuating member opens and closes the jaws.

C4. The load carrier of any of paragraphs C1 to C3, wherein the base defines a channel extending parallel to a long axis of the base, and wherein at least a portion of the anchor member is disposed in the channel.

C5. The load carrier of paragraph C4, wherein the channel is enclosed.

C6. The load carrier of any of paragraphs C1 to C5, wherein the anchor member is a first anchor member, wherein the linkage also includes a second anchor member that has an elastic connection to the first anchor member, and wherein manipulation of the actuating member causes both anchor members to travel along a same axis.

C7. The load carrier of any of paragraphs C1 to C6, wherein the anchor member is a first anchor member, wherein the linkage also includes a second anchor member that has an elastic connection to the first anchor member, and wherein manipulation of the actuating member causes both anchor members to move in a track defined by the base.

C8. The load carrier of any of paragraphs C1 to C7, wherein the anchor member is a first anchor member, wherein the linkage also includes a second anchor member that has an elastic connection to the first anchor member and is positionally coupled to the actuating member such that the manipulation of the actuating member drives the second anchor member back and forth.

C9. The load carrier of paragraph C8, wherein pivotal motion of the actuating member drives the second anchor member back and forth along the base.

C10. The load carrier of paragraph C8 or C9, wherein the elastic connection includes at least one tension spring that deforms to increase a distance between the anchor members after the jaws opposingly engage the frame portion and before the actuating member fixes the first anchor member.

C11. The load carrier of any of paragraphs C1 to C10, wherein the first portion of the linkage includes a cable that extends from the arm to the base.

C12. The load carrier of paragraph C11, wherein the first portion of the linkage includes a pair of cables that each extend from the arm to the base.

C13. The load carrier of paragraph C12, wherein the pair of cables cross one another between the arm and the anchor member.

D1. A load carrier mountable to a vehicle and configured to hold a bicycle in a fixed position above the roof of the vehicle, comprising: (i) a base; (ii) at least one wheel-binding device to secure a wheel of a bicycle to the base; (iii) an arm having a first end connected to the base and a second end including a gripping device having a pair of jaws to grip a frame portion of the bicycle; (iv) an actuating member manipulable to close the jaws to grip the frame portion and to open the jaws to release the frame portion; and (v) a linkage that operatively connects the actuating member to the gripping device, the linkage including a pair of anchor members having an elastic connection to each other and each moving with respect to the arm during manipulation of the actuating member that closes and opens the jaws.

E1. A load carrier mountable to a vehicle and configured to hold a bicycle in a fixed position above the roof of the vehicle, comprising: (i) a base; (ii) a gripping device connected to the base and configured to grip a frame portion of a bicycle; and (iii) a pair of wheel-binding devices to secure respective wheels of the bicycle to the base, the wheel-binding devices each being slidable along the base independently of one another.

E2. The load carrier of paragraph E1, wherein the base forms a track that each of the wheel-binding devices slides in.

E3. The load carrier of paragraph E2, wherein the track is formed by an upper portion of the base.

E4. The load carrier of paragraph E2 or E3, wherein the track is formed by a top side of the base.

E5. The load carrier of any of paragraphs E1 to E4, further comprising an arm having a first end connected to the base and a second end that includes the gripping device, wherein each of the wheel-binding devices is slidable along the base while the first end of the arm remains at a same position along the base.

E6. The load carrier of any of paragraphs E1 to E5, wherein each wheel-binding device has a mounting region that mates with a top side of the base to connect the wheel-binding device to the base.

E7. The load carrier of any of paragraphs E1 to E6, wherein the base forms an upper track and a lower track, wherein each of the wheel-binding devices is slidable in the upper track, further comprising a coupling device that mounts the base to a crossbar, the coupling device being slidable in the lower track.

E8. The load carrier of paragraph E7, wherein the coupling device is slidable along the base independently of each wheel-binding device.

E9. The load carrier of paragraph E7 or E8, wherein the coupling device is slidable past a wheel-binding device while the wheel-binding device stays at a same position on the base.

E10. The load carrier of any of paragraphs E7 to E9, wherein the base defines an enclosed longitudinal channel intermediate the upper and lower tracks.

F1. A load carrier mountable to a roof of a vehicle and configured to hold a bicycle in a fixed position above the vehicle, comprising: (i) a base; (ii) at least one wheel-binding device to secure at least one wheel of the bicycle to the base (iii) a coupling device that attaches the base to a crossbar and adjustable between an engaged configuration that secures the coupling device to the crossbar and a disengaged configuration that releases the coupling device from the crossbar; (iv) a locking mechanism extending along the base; and (v) an actuating member connected to the base separately from the coupling device at a position spaced along the base from the coupling device and operable to adjust the locking mechanism between a first configuration that prevents adjustment of the coupling device from the engaged configuration to the disengaged configuration and a second configuration that permits such adjustment.

F2. The load carrier of paragraph F1, wherein the actuating member is operatively connected to a bicycle-securing device.

F3. The load carrier of paragraph F2, wherein the bicycle-securing device is configured to grip a frame portion of a bicycle.

F4. The load carrier of paragraph F2, wherein the bicycle-securing device is configured to grip a wheel fork of a bicycle.

F5. The load carrier of any of paragraphs F1 to F4, wherein the locking mechanism has a portion that moves longitudinally inside the base when the locking mechanism is adjusted between the first configuration and the second configuration.

F6. The load carrier of paragraph F5, wherein the portion has a spring-biased position along the base.

F7. The load carrier of any of paragraphs F1 to F6, wherein the locking mechanism includes a locking member and a pusher that urges the locking member into an opening defined by an actuator of the coupling device when the actuating member connected to the base is adjusted from the first configuration to the second configuration.

F8. The load carrier of paragraph F7, wherein the locking member is a spring-biased pin that projects into an actuator of the coupling device.

G1. A load carrier mountable to a roof of a vehicle and configured to hold a bicycle in a fixed position above the vehicle, comprising: (i) a base; (ii) at least one wheel-binding device to secure at least one wheel of the bicycle to the base; (iii) an arm having a first end connected to the base and a second end including a gripping device having a pair of jaws to grip a frame portion of the bicycle; (iv) at least one elastic element that urges the jaws closed; and (v) a linkage operatively connected to the gripping device such that tensioning the linkage urges the jaws open; and (vi) at least one ratchet that prevents the jaws from opening without tensioning the linkage, while permitting the jaws to close.

G2. The load carrier of paragraph G1, wherein the at least one ratchet is disposed at the second end of the arm.

G3. The load carrier of paragraph G1 or G2, wherein the gripping device includes a pair of ratchets each associated with a distinct jaw.

G4. The load carrier of paragraph G3, wherein the ratchets have an angular offset relative to each other.

G5. The load carrier of paragraph G3 or G4, wherein the ratchets mesh in alternation as the jaws of the gripping device close.

G6. The load carrier of any of paragraphs G1 to G5, wherein the linkage is operatively connected to the at least one ratchet such that adjusting the linkage disengages the at least one ratchet to permit the jaws to open.

G7. The load carrier of any of paragraphs G1 to G6, wherein tensioning the linkage disengages the at least one ratchet and opens the jaws.

H1. A load carrier mountable to a vehicle and configured to support and hold an article adjacent the vehicle, comprising: (i) a base defining a longitudinal compartment; (ii) a clamping device connected to the base and having a pair of jaws; (iii) an actuator mounted on the base separately from the clamping device; and (iv) a linkage that operatively connects the actuator to the clamping device such that manipulation of the actuator adjusts a gap between the jaws of the clamping device, the linkage extending along the base in the longitudinal compartment.

H2. The load carrier of paragraph H1, wherein the base also defines a track, further comprising an article-securing device slidably disposed in the track.

H3. The load carrier of paragraph H2, wherein the article-securing device is a wheel-binding device.

H4. The load carrier of any of paragraphs H1 to H3, wherein pivotal motion of the actuator adjusts the gap between the jaws.

H5. The load carrier of any of paragraphs H1 to H4, wherein the base defines a pair of tracks, further comprising a crossbar-coupling device slidably disposed in one of the tracks.

H6. The load carrier of any of paragraphs H1 to H5, wherein the clamping device is included in an arm that is pivotally connected to the base.

H7. The load carrier of any of paragraphs H1 to H6, wherein the clamping devices clamps parallel to a horizontal axis that is orthogonal to the base.

While methods/devices for carrying a load on a vehicle have been particularly shown and described, many variations may be made therein. This disclosure may include one or more independent or interdependent embodiments directed to various combinations of features, functions, elements and/or properties. Other combinations and sub-combinations of features, functions, elements and/or properties may be claimed later in a related application. Such variations, whether they are directed to different combinations or directed to the same combinations, whether different, broader, narrower or equal in scope, are also regarded as included within the subject matter of the present disclosure. Accordingly, the foregoing embodiments are illustrative, and no single feature or element, or combination thereof, is essential to all possible combinations that may be claimed in this or a later application. Each example defines one or more embodiments disclosed in the foregoing disclosure, but any one example does not necessarily encompass all features or combinations that may be eventually claimed. Where the description recites “a” or “a first” element or the equivalent thereof, such description includes one or more such elements, neither requiring nor excluding two or more such elements. Further, ordinal indicators, such as first, second, or third, for identified elements are used to distinguish between the elements, and do not indicate a limiting number of such elements, and do not indicate a particular position or order of such elements unless otherwise specifically stated.

We claim:

1. A load carrier mountable to a vehicle and configured to hold a bicycle above the roof of the vehicle, comprising:
an elongate base;
at least one wheel-binding device to secure at least one wheel of a bicycle to the base;
an arm having a first end connected to the base and a second end including a gripping device having a pair of jaws to grip a frame portion of the bicycle; and
an actuating member operatively connected to the gripping device such that manipulation of the actuating member closes the jaws to grip the frame portion and opens the jaws to release the frame portion, the actuating member and the arm being mounted to the base separately from each other.

2. The load carrier of claim 1, wherein the actuating member is centered transversely on the base.

3. The load carrier of claim 1, wherein the arm is pivotally connected to the base and is pivotable with respect to the base without moving the actuating member with respect to the base.

4. The load carrier of claim 1, wherein the first end of the arm and the actuating member are mounted to the base at respective sites that are spaced from each other along the base.

5. The load carrier of claim 1, wherein the base defines a longitudinal channel, further comprising a linkage that operatively connects the actuating member to the gripping device, a portion of the linkage being disposed in and extending along the channel.

6. The load carrier of claim 5, wherein the linkage includes a cable that extends along the channel and into the arm.

7. The load carrier of claim 6, wherein the linkage has opposing ends and includes a pair of cables that cross one another intermediate the opposing ends.

8. A load carrier mountable to a vehicle and configured to hold a bicycle above the roof of the vehicle, comprising:
an elongate base;
a pair of wheel-binding devices to secure respective wheels of a bicycle to the base and slidable along the base independently of one another;
an arm having a first end connected to the base and a second end including a gripping device having a pair of jaws to grip a frame portion of the bicycle; and
an actuating member operatively connected to the gripping device such that manipulation of the actuating member closes the jaws to grip the frame portion and opens the jaws to release the frame portion.

9. The load carrier of claim 8, wherein the base forms a track that each of the wheel-binding devices slides in.

10. The load carrier of claim 9, wherein the track is formed by an upper portion of the base.

11. The load carrier of claim 10, wherein the track is formed by a top side of the base.

12. The load carrier of claim 8, further comprising an arm having a first end connected to the base and a second end that includes the gripping device, wherein each of the wheel-binding devices is slidable along the base while the first end of the arm remains at a same position along the base.

13. The load carrier of claim 8, wherein each wheel-binding device has a mounting region that mates with a top side of the base to connect the wheel-binding device to the base.

14. The load carrier of claim 8, wherein the base forms an upper track and a lower track, wherein each of the wheel-binding devices is slidable in the upper track, further comprising a coupling device that mounts the base to a crossbar, the coupling device being slidable in the lower track.

15. The load carrier of claim 14, wherein the coupling device is slidable along the base in the lower track independently of each wheel-binding device.

16. A load carrier mountable to a vehicle and configured to hold a bicycle in a fixed position above the roof of the vehicle, comprising:
an elongate base;
at least one wheel-binding device to secure a wheel of a bicycle to the base;
an arm having a first end connected to the base and a second end including a gripping device having a pair of jaws to grip a frame portion of the bicycle;
an actuating member; and
a linkage operatively connecting the actuating member to the gripping device such that manipulation of the actuating member opens and closes the jaws via the linkage, the linkage including a first portion extending from the gripping device to an anchor member that is engageable with the actuating member to fix the anchor member and a second portion extending from the anchor member to the actuating member and having a variable length.

17. The load carrier of claim 16, wherein the second portion of the linkage includes an elastic element that deforms in response to the actuating member being adjusted from a first position at which the jaws opposingly engage the frame portion of the bicycle to a second position that fixes the anchor member.

18. The load carrier of claim 16, wherein the anchor member travels in a track of the base when the actuating member opens and closes the jaws.

19. The load carrier of claim 18, wherein the track is formed at least in part by an enclosed longitudinal channel defined by the base.

20. The load carrier of claim 18, wherein the anchor member is a first anchor member, wherein the linkage also includes a second anchor member that has an elastic connection to the first anchor member, and wherein manipulation of the actuating member causes both anchor members to move in the track of the base.
